(19) United States
(12) Patent Application Publication
(10) Pub. No.: US 2006/0031091 A1
(43) Pub. Date: Feb. 9, 2006

(54) System and method for providing custom stock images

(76) Inventors: Christopher A. Tarr, Evergreen, CO (US); David L. Norris, Kirkland, WA (US); Daniel Thaine Norris, Longmont, CO (US)

Correspondence Address: BAKER BOTTS L.L.P., 2001 ROSS AVENUE, SUITE 600, DALLAS, TX, 75201-2980, US

(21) Appl. No.: 11/249,068

(22) Filed: Oct. 12, 2005

Related U.S. Application Data
(63) Continuation of application No. 10/815,446, filed on Mar. 31, 2004.

(51) Int. Cl. G06Q 99/00

(52) U.S. Cl. 705/1

(57) ABSTRACT

A method for providing images to a customer is provided. The method includes receiving a request for at least one image from a customer. Software on a computer server is used to select a plurality of photographers from a photographer network in response to the request. An uploaded image is received from each of at least two photographers. The uploaded images are displayed to the customer for selection of at least one image in fulfillment of the request, and a selected uploaded image is provided to the customer after the customer agrees to execute a license to use the uploaded image.

### CROSS REFERENCE TO RELATED APPLICATION

This application is a continuation of U.S. application Ser. No. 10/815,446, filed Mar. 31, 2004, and entitled “System and Method for Providing Custom Stock Images.”

### TECHNICAL FIELD OF THE INVENTION

This invention relates generally to systems and methods for providing and managing images and more particularly to a system and method for providing custom stock images.

### BACKGROUND OF THE INVENTION

Images are a powerful addition to many forms of advertising and news reporting. In many circumstances, a “stock” image will suffice for an advertisement or a news story. For example, it may not be necessary for an organization, such as an advertising agency, corporate design department, and/or a news reporting agency, to send a photographer to “shoot” a common image, such as an image of an airplane taking off from an airport, or a sports car racing around a racetrack. In these instances, customers may rely on conventional stock image resources, such as the large stockpiles of images available from Getty Images or Corbis, to provide, for a fee, a stock image of the desired subject.

However, conventional stock image libraries may not contain a specific image desired by a customer. For example, a stock image library may not contain an image of a red Ferrari racing through mountain roads in the Swiss Alps, a particular image that the customer may desire, thereby necessitating that the customer hire a professional photographer to create the precise image. Hiring a professional photographer to provide a specific image can be very costly and time consuming for the customer, as it may take a long period of time to logistically organize the “photo shoot.” Furthermore, by hiring a specific photographer, the customer is limited to selecting the images created by that photographer.

### SUMMARY OF THE INVENTION

In one embodiment, a method for providing images to a customer is provided. The method includes receiving a request for at least one image from a customer. Software on a computer server is used to select a plurality of photographers from a photographer network in response to the request. An uploaded image is received from each of at least two photographers. The uploaded images are displayed to the customer for selection of at least one image in fulfillment of the request, and a selected uploaded image is provided to the customer after the customer agrees to execute a license to use the uploaded image.

Technical advantages of one or more embodiments of the present invention may include the ability to provide custom stock images to a customer in a short period of time. Another technical advantage of one or more embodiments of the present invention may include the ability to provider a customer with similar images created by numerous photographers, thereby increasing the likelihood that the customer will be satisfied with the images. Still other technical advantages of one or more embodiments of the present invention may include provided unique “on demand” images and providing photographer management for the customer. Another technical advantage of one or more embodiments of the present invention includes the ability to select from a vast number of photographers with various qualifications to tailor photographers to the specific criteria of the desire image. Another technical advantage of the present invention may include the ability to provide custom artistic content, such as audio, video, and text content, in a short period of time based on a customer's request.

Certain embodiments may provide all, some, or none of these technical advantages. Certain embodiments may provide one or more other technical advantages, one or more of which may be readily apparent to those skilled in the art from the figures, description, and claims included herein.

### BRIEF DESCRIPTION OF THE DRAWINGS

To provide a more complete understanding of the present invention and certain features and advantages thereof, reference is made to the following description taken in conjunction with the accompanying drawings, in which:

FIG. 1 is a block diagram of one embodiment of a system for providing custom stock images;

FIG. 2 illustrates an example computer architecture associated with the system of FIG. 1;

FIG. 3A illustrates an example relationship between the staffing manager and assignment workflow manager of FIG. 2;

FIG. 3B illustrates an example staffing data flow;

FIG. 4A is a block diagram illustrating an example of project and assignment data;

FIG. 4B is a block diagram illustrating example domain data for an image;

FIGS. 5A-5K illustrate example graphical user interfaces associated with the system of FIG. 1;

FIG. 6A illustrates an example method for adding a photographer to the photographer network of the system of FIG. 1;

FIG. 6B illustrates another example method for adding a photographer to the photographer network of the system of FIG. 1;

FIG. 7 illustrates an example photographer rating “tree”;

FIG. 8A illustrates an example method for creating a new assignment;

FIG. 8B illustrates an example method for changing an existing assignment;

FIG. 9A illustrates an example invite process;

FIG. 9B illustrates an example review process;

FIG. 9C illustrates an example assignment process;

FIG. 10 illustrates an example method for processing an uploaded image;

FIG. 11A illustrates an example method for resolving unassociated release document images; and

FIG. 11B illustrates an example method for downloading an image.

### DETAILED DESCRIPTION OF EXAMPLE EMBODIMENTS

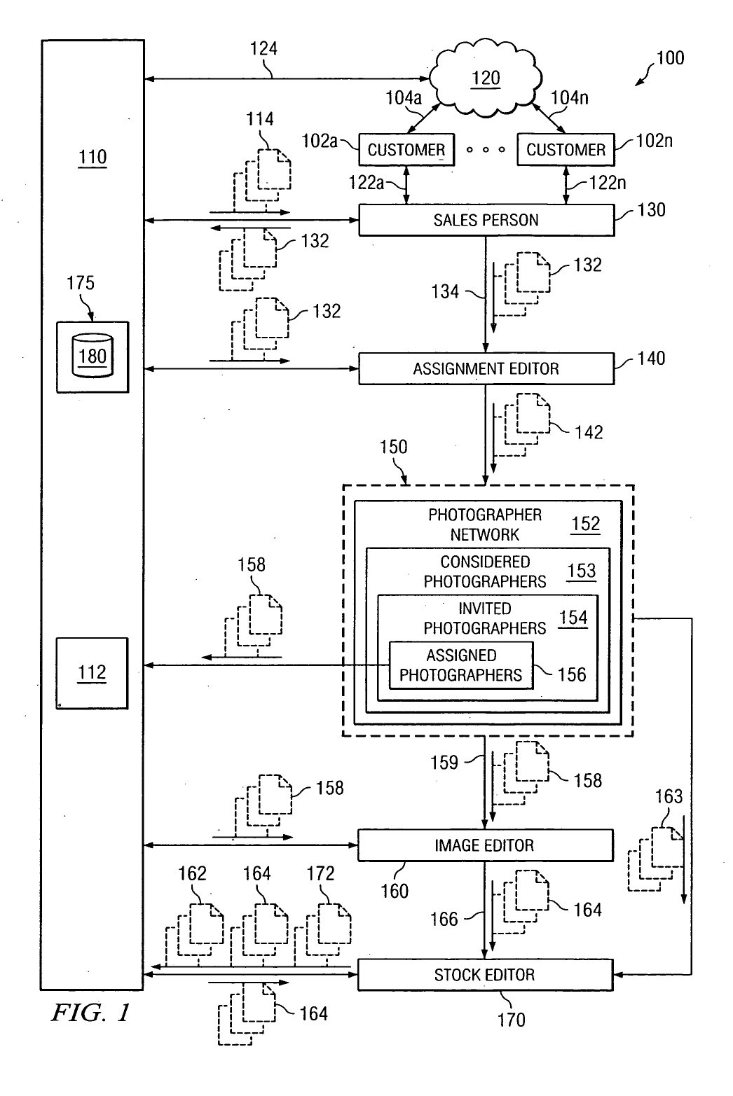

FIG. 1 is a block diagram of one embodiment of a system 100 for providing custom stock images. FIG. 1 illustrates just one example of system 100. It should be appreciated that other embodiments of system 100 may be used without departing from the scope of the present disclosure. In this example system 100 may include one or more customers 102a-102n, a server 110, a network 120, a sales person 130, an assignment editor 140, a photographer selection subsystem 150, an image editor 160, a stock editor 170, an image library 175, and a stock image library 180. System 100 is capable of providing a custom stock image to customers 102, based on the particular image requirements of customers 102. Customers 102 may include, for example, advertising agencies, graphic design firms, corporate marketing departments, publishers, and/or any other individuals or entities desiring to license and use custom stock images using system 100. The image may be provided to customers 102 by system 100 through agreements such as an outright assignment, a “rights-managed” license agreement, a limited exclusive license agreement, or any other appropriate manner in which to convey at least some limited rights to customers 102 in the provided image. Although FIG. 1 illustrates network 120 coupling customers 102 with server 110, in certain embodiments, network 120 may also couple server 110 to sales person 130, assignment editor 140, photographer selection subsystem 150, image editor 160 and stock editor 170.

In general, system 100 is operable to allow customer 102 to place a custom order for an image that customer 102 requires, such as for use in an advertising campaign or a news article. System 100 contains a network of photographers who may be assigned to conduct a “photo shoot” to obtain the image desired by customer 102. Images that were “shot” in response to a photography assignment may be uploaded to system 100, where the images may be edited and prepared for submission to customer 102. Furthermore, images that may already exist and which satisfy the requirements of the assignment without the need for an additional photo shoot may also be uploaded to system 100. System 100 also allows photographers in its photographer network to upload images that where previously shot (but not in response to an assignment), as well as those images that were “shot” in response to a photography assignment, in order to create a library of stock images that may be accessed for later use by customers 102. System 100 manages the photographers, images, and the licenses of those images.

In this example system 100 includes a server 110 capable of performing a desired communicating and/or computing functionality. As non-limiting examples, server 110 may comprise an interactive web-based system, an agent-based system, or a combination of these or other data communication systems. Server 110 may comprise any device or combination of devices that may include one or more software and/or firmware modules. In various embodiments, server 110 may comprise, for example, one or more memory modules and one or more software engines. In this embodiment, server 110 executes object-oriented, database-based, web-interfaced software 112 with associated storage capabilities on server 110. In one particular non-limiting example, software 112 may execute a series of queries requesting information and/or data from a user of server 110. In some cases, software 112 may include, for example, HTML-based templates, XML-based templates, or a combination of these or other templating formats to present queries to the user. There are three user audiences for the user interface: (1) Photographers, (2) Customers, and (3) Internal Users. Each user audience may include several interfaces and sub-interfaces, which are described in more detail below.

In certain embodiments, server 110 may include a memory operable to store an image library 175. Image library 175 is discussed in more detail below. In general, image library is operable to store an accumulated inventory of images available for access using system 100. Image library 175 may include a stock image library 180 that contains images classified as “stock” images, as discussed in more detail below.

In one particular embodiment, server 110 receives and/or communicates information through a network 120 coupled to server 110. As used throughout this document, the term “couple” and/or “coupled” refers to any direct or indirect communication between two or more elements, whether or not those elements are in physical contact with one another. In this example, server 110 couples to network 120 through communications link 124.

Network 120 may comprise any wireless network, wireline network, or combination of wireless and wireline networks capable of supporting communication between network elements using ground based and/or space based components. For example, network 120 may comprise a data network, an integrated services digital network (ISDN), a local area network (LAN), a wide area network (WAN), a metropolitan area network (MAN), all or a portion of the global computer network known as the internet, and/or other communication systems or combinations of communication systems at one or more locations.

One or more customers 102 may communicate with server 110 through network 120 via communications links 104 using any appropriate computing and/or communication device capable of enabling the communication of information to or from server 110 over network 120. Each customer 102 may use, for example, a wireless device, a voice over IP device, a desktop computer, a laptop computer, a personal digital assistant, a workstation, a mainframe computer, a miniframe computer, a web server, or any other computing and/or communicating device for communicating with server 110.

In certain embodiments, a customer 102 may use a telephone to initiate communications with a sales person 130 over a communications link. In this particular embodiment, salesperson 130 is capable of making outbound calls to and accepting inbound calls from customer 102 over communications link 122. The content of this telephone call may contain a request from customer 102 for the creation and/or licensing of custom stock photographic images for use by customer 102 in, for example, an advertising campaign or a news article. Salesperson 130 may query customer 102 to determine the specific image criteria required, such as the location, subject matter, and resolution of the image, as well as the deadline for providing the image. In certain embodiments, salesperson 130 may also negotiate the price of providing the photographic image with customer 102. Salesperson 130 is responsible for accepting the request from customer 102 and converting those requests into one or more sales orders 132 for submission to an assignment editor 140. For example, salesperson 130 may complete a new sales order 132 and/or modify a copy of an existing sales order 132. Sales order 132 may be a “stand-alone” order or it may be part of a group of related sales orders, referred to in this disclosure as a “project.”

In addition to being responsible for accepting customer requests and converting them into sales orders 132, in certain embodiments, salesperson 132 may be responsible for maintaining customer relationships and account information. For example, salesperson 130 may be responsible for adding, deleting, and/or editing customer user profiles, maintaining basic customer information, and/or setting up new customer accounts.

In certain embodiments, salesperson 130 may transmit sales order 132 to server 110 and assignment editor 140 may retrieve sales order 132 from server 110. In an alternate embodiment, customer 102 may place a request for one or more custom stock photographic images using, for example, a personal computer with a graphic user interface (GUI), to communicate with server 110 through network 120. In this particular embodiment, server 110 may execute software 112 to enable one or more web-based interfaces, which are viewable to customer 102 using the GUI. Software 112 may be executed to generate one or more templates to query customer to determine the specific image criteria required, similar to the way that salesperson 130 queries customer 102, as described above. Customer 102 may input specific information relating to the desired image into an order form template. As discussed above, the information submitted by customer 102 may include the content of the image, the resolution of the image and/or any other information specific to the image request and may be communicated in several formats including images, text, audio, and video. In certain embodiments, software 112 executed by server 110 may generate a price quote for the photographic image request based on the submitted information. Software 112 may also generate a customer order 114, which contains the relevant information received by server 110 from customer 102. Customer order 114 may then be stored in a memory associated with server 110 until it is retrieved by sales person 130. In certain embodiments, customers 102 may search and review images stored in stock photo library 180 prior to generating a customer order 114 to determine, for example, if an image that meets their needs already exists in system 100.

Depending upon the particular embodiment of system 100, assignment editor 140 receives order 132 from server 110 or directly from salesperson 130, as illustrated in this example by arrow 134. Assignment editor 140 is responsible for creating an assignment based on one or more sales orders 132. An assignment is an order for the provision of an image to a customer 102. In certain embodiments, the assignment may not include certain confidential information contained in sales order 132, such as the customer's name, the customer's contact information, certain billing arrangements, and/or pricing information. In some embodiments, the assignment created by assignment editor 140 may also include additional information that sales order 132 does not include, such as additional descriptions of the photographic content of the desired image, image delivery information, customer history information, and any other information that may be pertinent to the request and provision of a custom stock photographic image. In certain embodiments, assignment editor 140 converts the assignment information into an assignment invitation 142. Assignment invitation 142 may contain the requirements of an assignment written in “photographer-speak,” plus other information, such as information regarding the fee, or royalty, that a photographer will receive if their image is used by customer 102. In other embodiments, assignment editor 140 may query stock image library 180 to determine if an image that meets the customer's requirements is already contained within system 100, thus avoiding the need to have a photographer create the image anew.

If stock image library 180 does not contain an image that meets the customer's requirements or if additional new images are needed, assignment editor 140 communicates assignment invitation 142 to a photographer selection subsystem 150. Although photographer selection subsystem 150 is illustrated in FIG. 1 as residing externally to server 110, photographer selection subsystem 150 may comprise one or more software engines associated with software 112 and one or more databases associated with server 110. Photographer selection subsystem 150 includes a photographer network 152. In certain embodiments, photographer network 152 comprises a database of one or more photographers available to fulfill an order for a photographic image. In a particular embodiment, photographers may pay a fee to be included in photographer network 152. The photographers may interface with system 100 as often as necessary. For example, but not by way of limitation, a photographer may interface with system 100 on a daily basis for a variety of purposes, such as to check on assignment status and/or updating the photographer's profile. In certain embodiments, the photographers may interface with system 100 using a GUI, or via e-mail, fax, voice communications, or through any other appropriate communication means.

Assignment editor 140 may search a database containing information associated with photographer network 152 and create a “pool” of photographers 153 that will be considered for the assignment. As is discussed in more detail below, the list of considered photographers 153 is also referred to as the “short list.” Based on various selection criteria including but not limited to a photographer's “point rating,” discussed in more detail below, assignment editor 140 may narrow the list of considered photographers 153 to a list of photographers 154 who will be invited to participate in the photo shoot. Assignment editor 140 may then broadcast an assignment invitation 142 to all invited photographers 154, for example, via an e-mail sent to each photographer. Those photographers 154 interested in accepting assignment invitation 142 may respond to that invitation, for example, through a GUI interface to server 110 or alternatively via a return e-mail, indicating that they are interested in being assigned to “shoot” the image or images requested by customer 102. Based on numerous selection criteria, such as a photographer's “point rating,” discussed in further detail below, assignment editor 140 may implement photographic selection subsystem 150 to narrow the list of invited photographers 154 who have responded as interested into a list (list 347c as described below) of assigned photographers 156 who meet the selection criteria. For example, the list of assigned photographers 156 may include five or ten photographers, so that multiple photographers are provided with an opportunity to provide images for customer 102, thereby increasing the likelihood that an image acceptable to customer 102 will be created. Assigned photographers 156 use the information provided in assignment invitation 142 to create one or more photographic images 158.

In addition to creating a pool of potential photographers and generating assignment invitations 142, in certain embodiments, assignment editor 140 may also be responsible for supporting the photographers while they are shooting and uploading the images, answering detailed questions about the photography assignments, and/or handling various other photographer-related issues that may arise.

Upon completion of the “photo shoot,” assigned photographers 156 may upload images 158 to a memory and/or storage device, such as those associated with image library 175 and server 110, accessible by image editor 160. In an alternative embodiment, assigned photographers 156 may upload images 158 directly to a storage device other than those associated with server 110, such as the hard drive of a laptop computer, accessible by image editor 160, as represented in FIG. 1 by arrow 159. In certain embodiments, in addition to uploaded images 158 being created in response to the current photo assignment, uploaded images 158 may also include images that members of photographer network 152 submit from their personal photo portfolio that match the requirements of the current photo assignment to image editor 160 to fulfill a photographer assignment. In certain embodiments, the photographers in photographer network 152 may also submit images 163 directly to stock editor 170 for inclusion in stock image library 180. In this case, images 163 generally include images that the photographers have not previously submitted to image editor 160 in response to a photo assignment. In all upload situations, the photographer may modify the images he shoots prior to uploading in order to improve the chances that the image will be selected by a customer. For example, a photographer may wish to edit out a feature of an image background using photo editing software to improve the quality of the image.

Image editor 160 may comprise an individual responsible for reviewing all images 158 that are uploaded relating to all assignment invitations 142 from all assigned photographers 156. Image editor 160 approves or rejects images 158 before the approved images 162 are made available for customer 102 to view and/or license. Approved images 162 are then communicated by image editor 160 to server 110. Customer 102 may access server 110 through network 120 to view approved images 162 in order to select an image prior to licensing an image.

In addition to selecting approved images 162, image editor 160 may also select images 158 for delivery to stock editor 170. This is generally done for those images that image editor 160 determines would be good additions to stock image library 180 (e.g., those images that image editor 160 determines to be “marketable”). Images 158 selected by image editor 160 for delivery to stock editor 170 are referred to as selected images 164. Image editor 160 transmits selected images 164 to stock editor 170, either directly, as illustrated by arrow 166, or through server 110. Stock editor 170 may comprise an individual responsible for adding keywords, descriptions, and/or captions to images 163 and selected images 164 so that images 163, 164 may be easily searched and located while stored in stock image library 180. Additionally, stock editor 170 is responsible for reviewing all images 163, 164 and making the final approval on which images are to be submitted to stock image library 180, a sub portion of image library 175 that contains images classified as “stock” images. Images 163, 164 are “queued up” in a memory device of system 100 accessible by stock editor 170 until stock editor 170 reviews the images, approves or rejects its addition to stock image library 180, and in the case of approving an image for addition to stock image library 180 add keywords, descriptions, captions or other annotation as required for future image location and use. Images 163, 164 that are key-worded and approved for addition to stock image library 180 by stock editor 170 are illustrated in FIG. 1 as key-worded images 172. Key-worded images 172 may be stored in stock image library 180 for future use by customers 102. For example, when a customer 102 submits an image request through either sales person 130 or server 110, as described above, image editor 140 may conduct a search of stock image library 180 to determine if an image meeting the customer's criteria has already been created and stored in stock image library 180. If such an image is found in stock image library 180, individual photographers from photographer network 152 do not need to be assigned to conduct a “photo shoot” to obtain the requested image.

Although the discussion above illustrates a system 100 for use in providing photographic custom stock images, any other form of artistic content may be provided using system 100. For example, but not by way of limitation, rather than photographs, system 100 may be implemented as discussed above to provide drawings, paintings, illustrations, audio content, video content, and text content (such as poems, short stories, news articles, etc.). Therefore, system 100 may provide assignments to artists, writers, videographers, musicians, film makers, or any other person producing artistic content in order to fulfill a customer order for custom stock artistic content. Although references throughout this disclosure refer to images, photo shoots, and photographers (or “shooters,” a term intended to be synonymous with photographers), the systems and methods described are applicable for use with a variety of artistic content provided by a variety of types of artists.

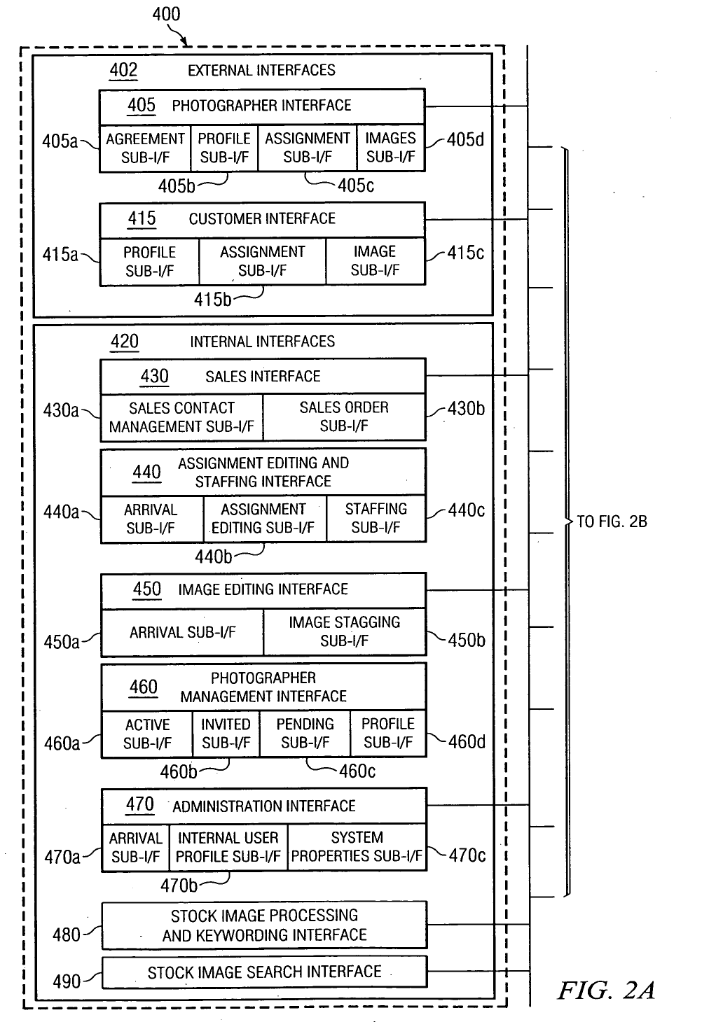

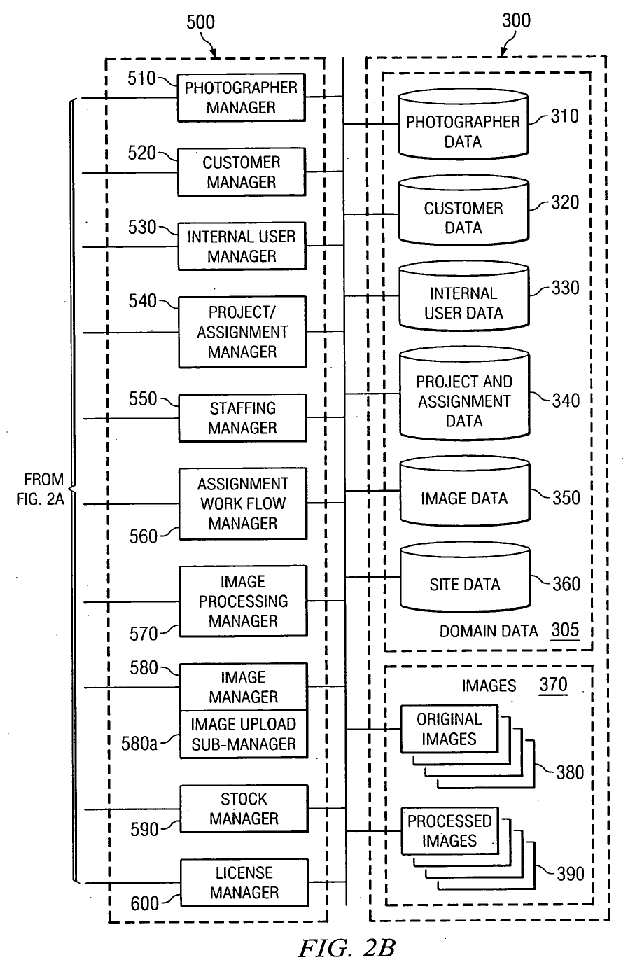

FIG. 2 illustrates example computer architecture 200 associated with system 100 for providing custom stock photographic images. Architecture 200 includes data layer 300, interface layer 400, and business layer 500. Layers 300, 400, and 500 may be directly or indirectly coupled to one another.

I. The Data Layer

In certain embodiments, data layer 300 includes two macro data types in system 100: domain data 305, and images 370. Domain data 305 and images 370 are inherently different data types and are managed differently by system 100. Domain data 305 is similar to the data contained in a form on a Web site. Domain data 305 is fine-grained and is preferably easily accessed and modified. Consequently, domain data 305 is typically stored in a traditional database. Images 370, however, are large, course-grained data, which are typically accessed and processed as units. In certain embodiments, images 370 may contain image sizes that may range from a few kilobytes to several hundred megabytes. As such, images 370 are more efficiently stored and managed as files in a large file system.

1. Domain Data

In certain embodiments, data layer 300 includes the following high-level domain data 305 contained in one or more databases: photographer data 310, customer data 320, internal user data 330, project and assignment data 340, image data 350, and site data 360. The data in photographer data 310, customer data 320, internal user data 330, project and assignment data 340, image data 350, and site data 360 may be stored as normalized tables in a relational database or as objects in an object-oriented database.

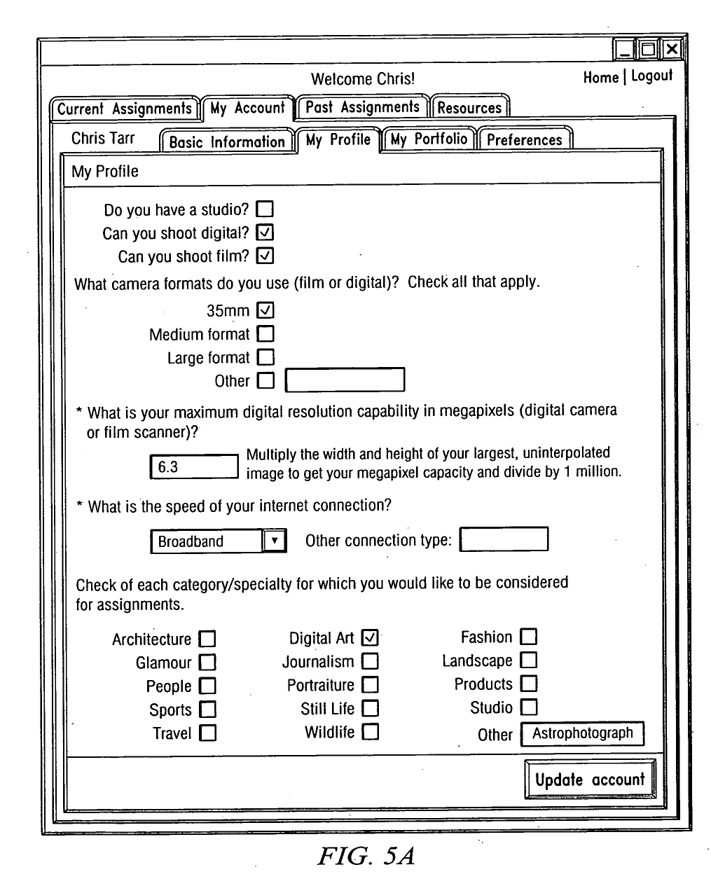

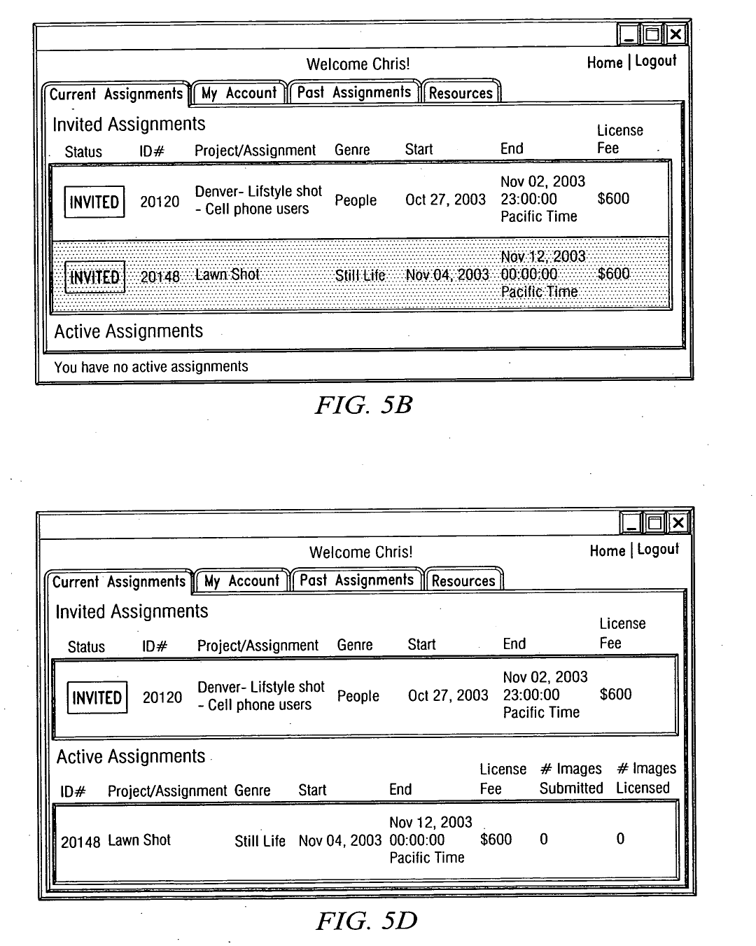

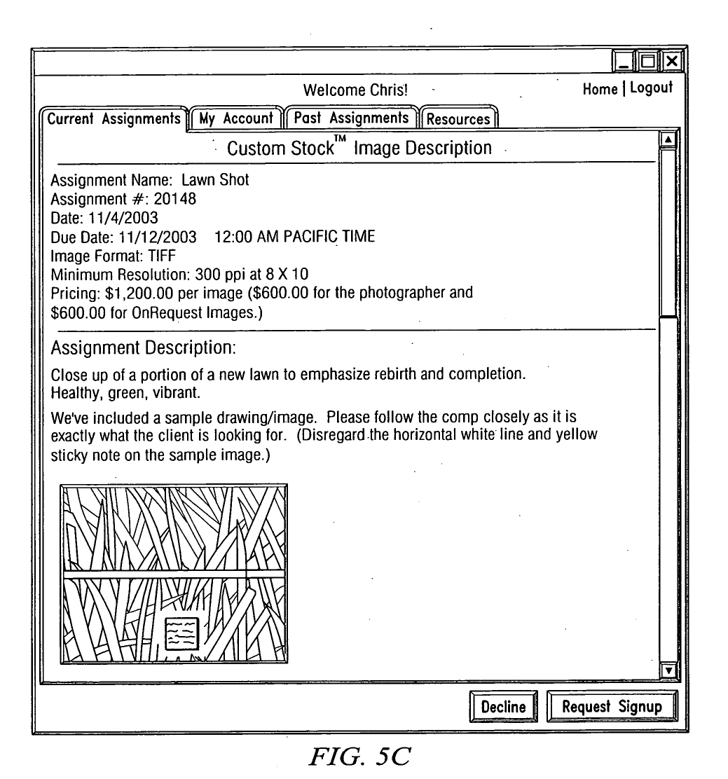

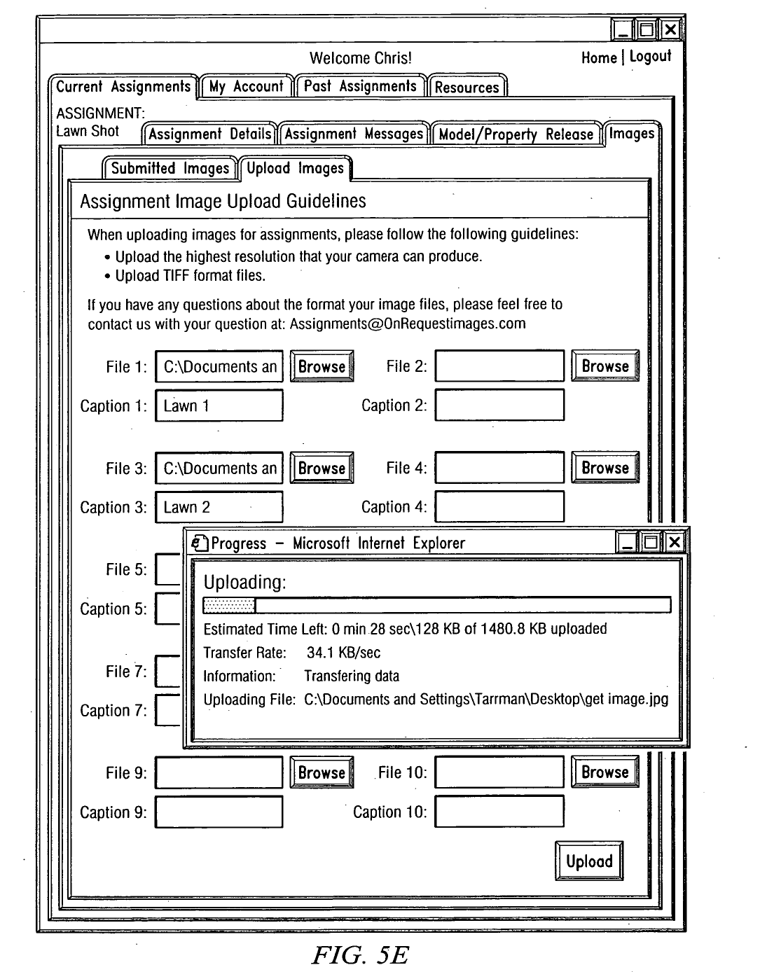

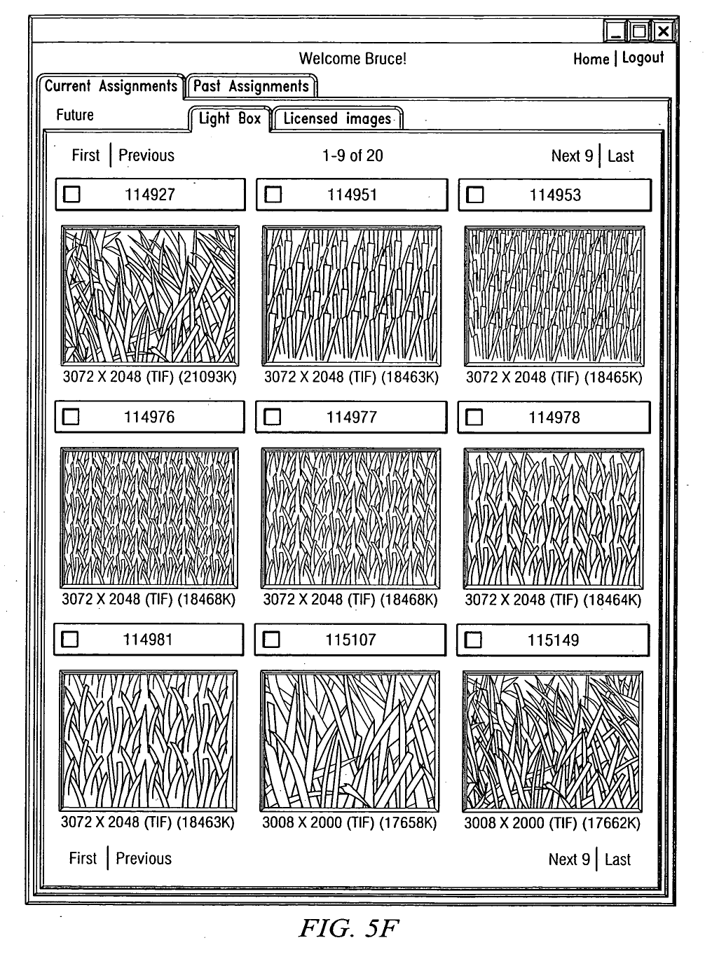

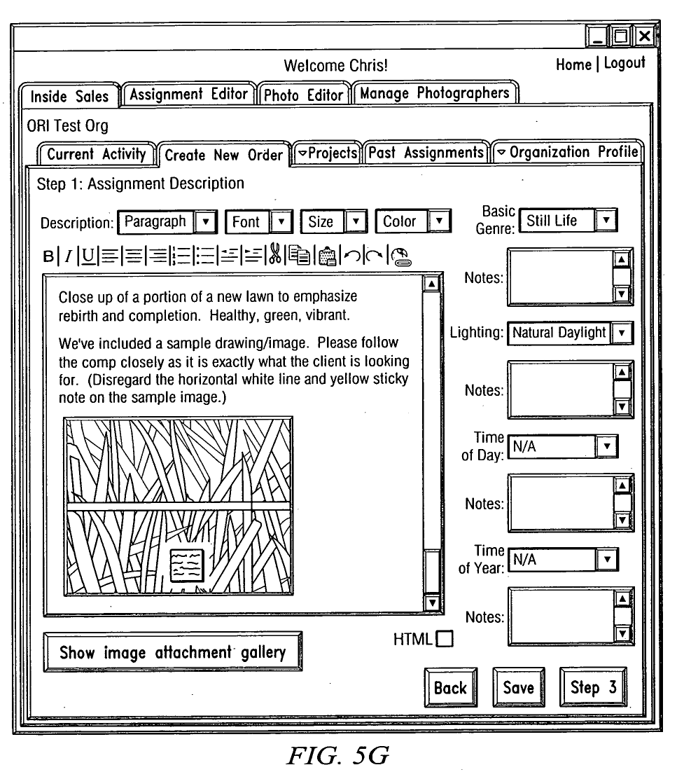

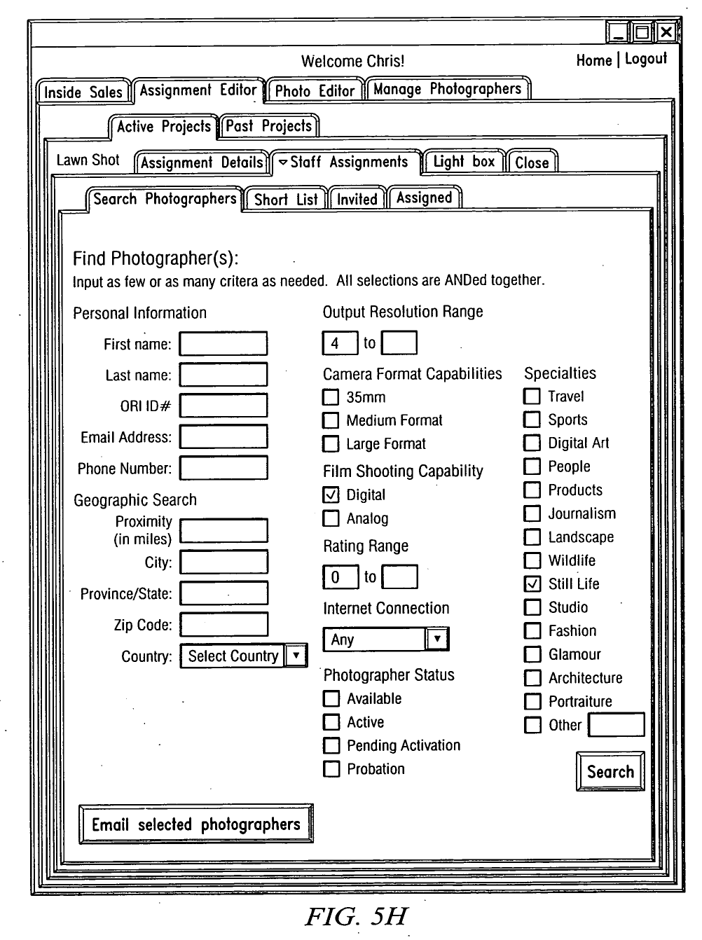

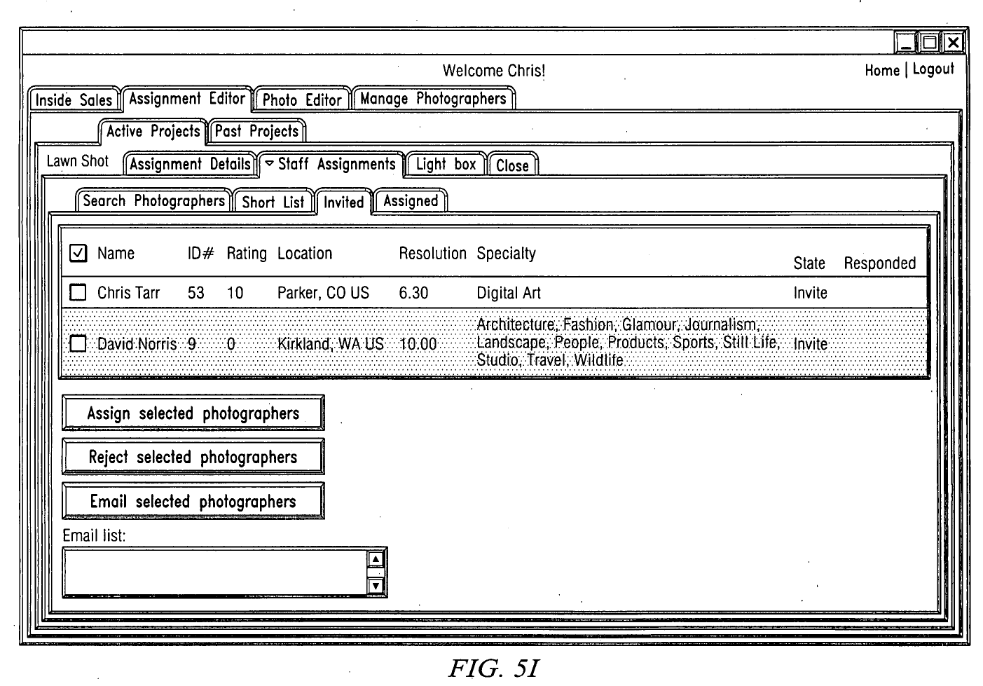

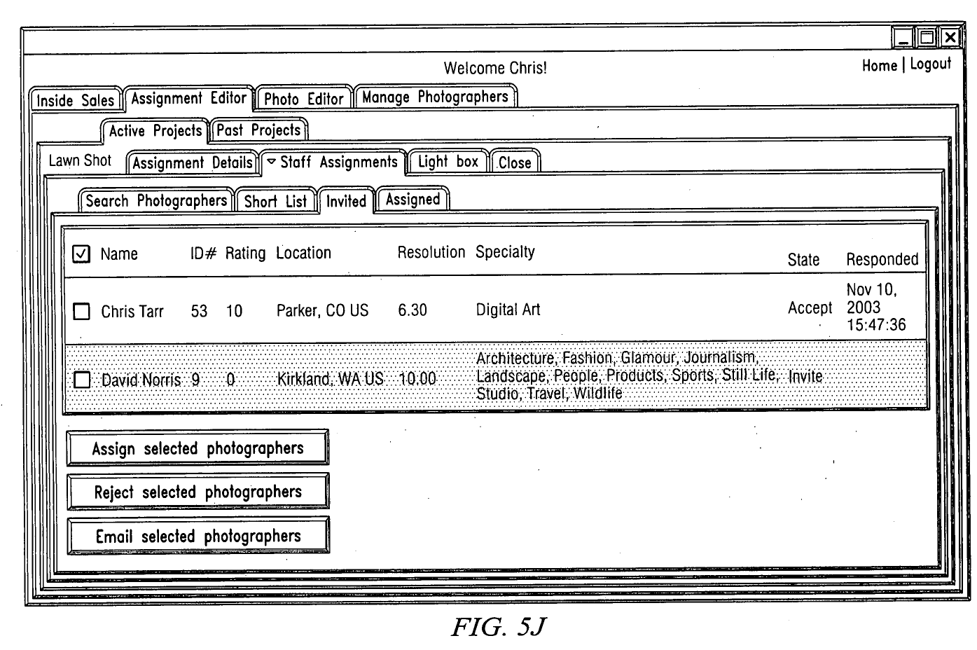

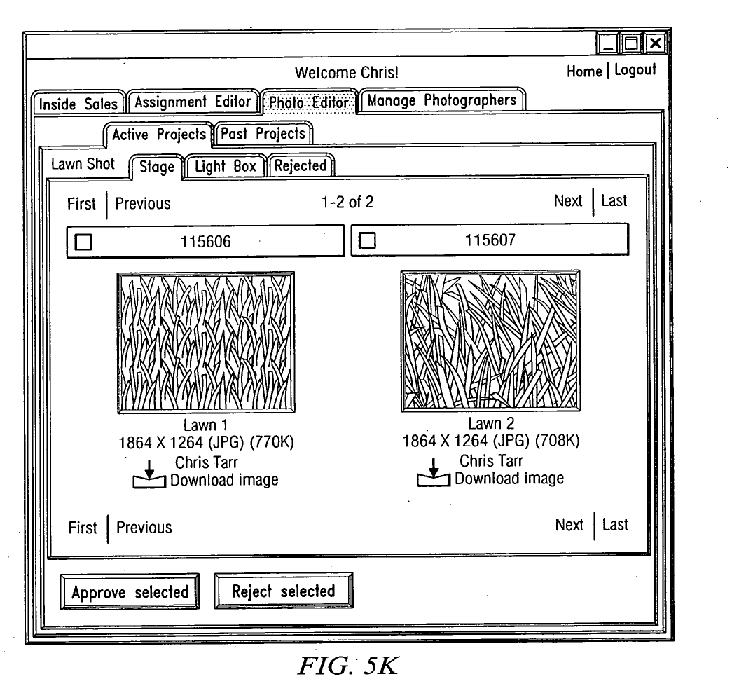

Photographer data 310 may contain data related to the photographer, such as each photographer's login identification and password, profile information, and/or contact information. Customer data 320 may contain data related to each customer 102, such as login identification and password, profile information, and/or organizational information. Internal user data 330 may contain the data related to internal users of system 100, such as salespersons 130, assignment editors 140, image editors 160, stock editors 170, and/or any other appropriate internal users of system 100. The data contained in internal user data 330 may include each internal user's login identification and password, user profile, preferences, and/or security privileges. In certain embodiments, when a photographer logs into system 100 they see the photographer interface 405, when customer 102 logs into system 100 they see the customer interface 415, and when an internal user logs into system 100, they see one or more of the internal interfaces 420 depending upon their security privileges. Interfaces 405, 415, and 420 are described in more detail below with reference to FIGS. 5A-5K.

Although specific examples of the types of data contained in data 310, 320, and 330 are described above, any appropriate information may be contained in data 310, 320, and 330 depending upon particular needs.

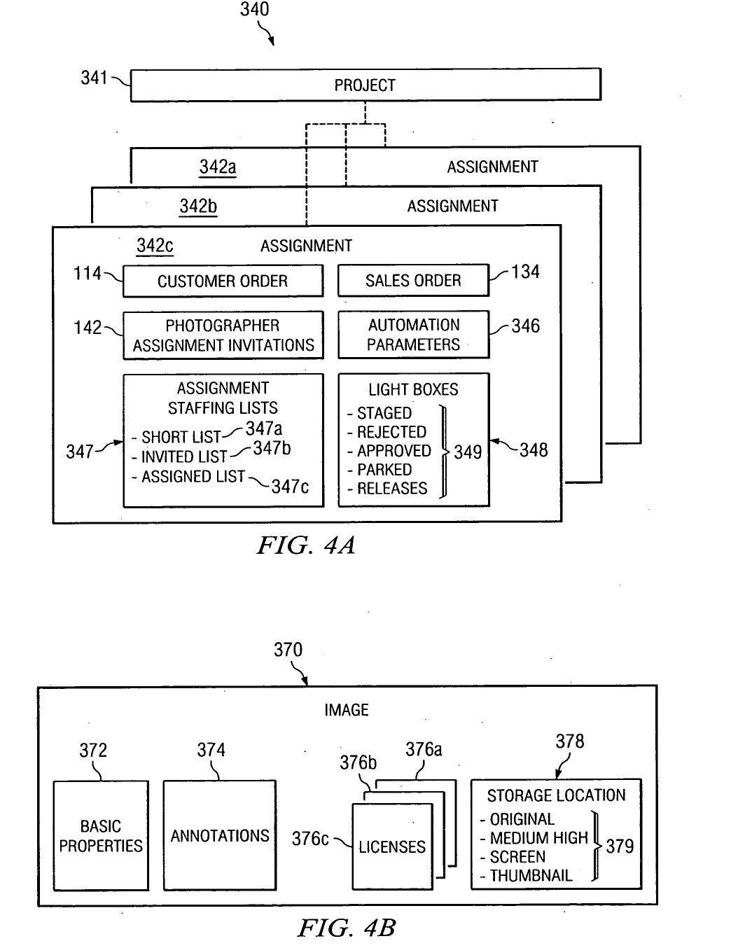

Domain data 305 may also include project and assignment data 340. Assignments, as described above, are orders for the provision of an image to a customer 102. Assignments may occur in related groups, known as “projects.” A project is similar to a folder that contains one or more assignments. In certain embodiments, an assignment may be composed of six basic data groups: customer orders, sales orders, photographer assignment invitations, automation parameters, assignment staffing lists, and lightboxes. FIG. 4A, discussed below, illustrates an example relationship between assignments and projects and provides further details regarding the six data groups of an assignment.

Domain data 305 may also include image data 350. Although, in some embodiments, the actual images, such as images 158, 162, 163, 164, and/or 172, may be stored in a flat file, as discussed below, many image properties and relationships associated with an image may be stored as domain data 305. In certain embodiments, each image, such as images 158, 162, 163, 164, and/or 172, may comprise the following data groups: basic properties, annotations, licenses, and storage locations. FIG. 4B, discussed below, illustrates example domain data for an image and provides further details of image data groups.

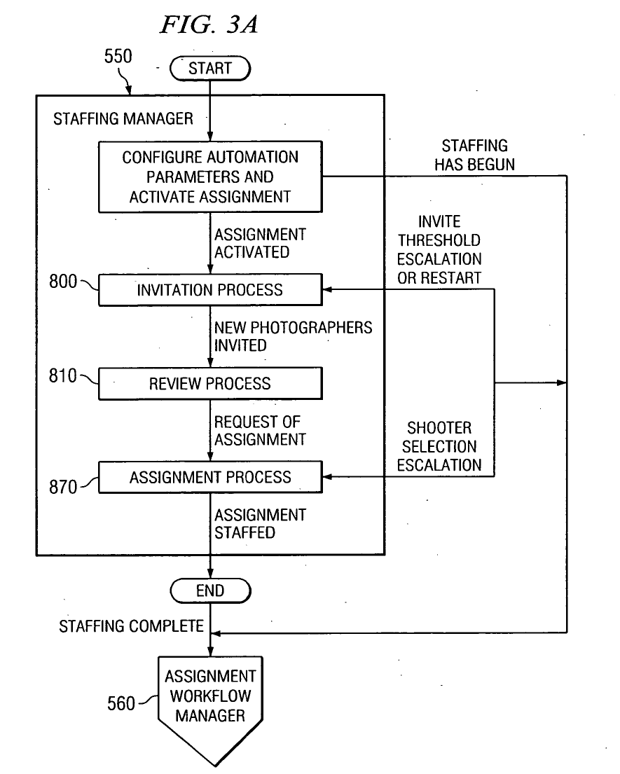

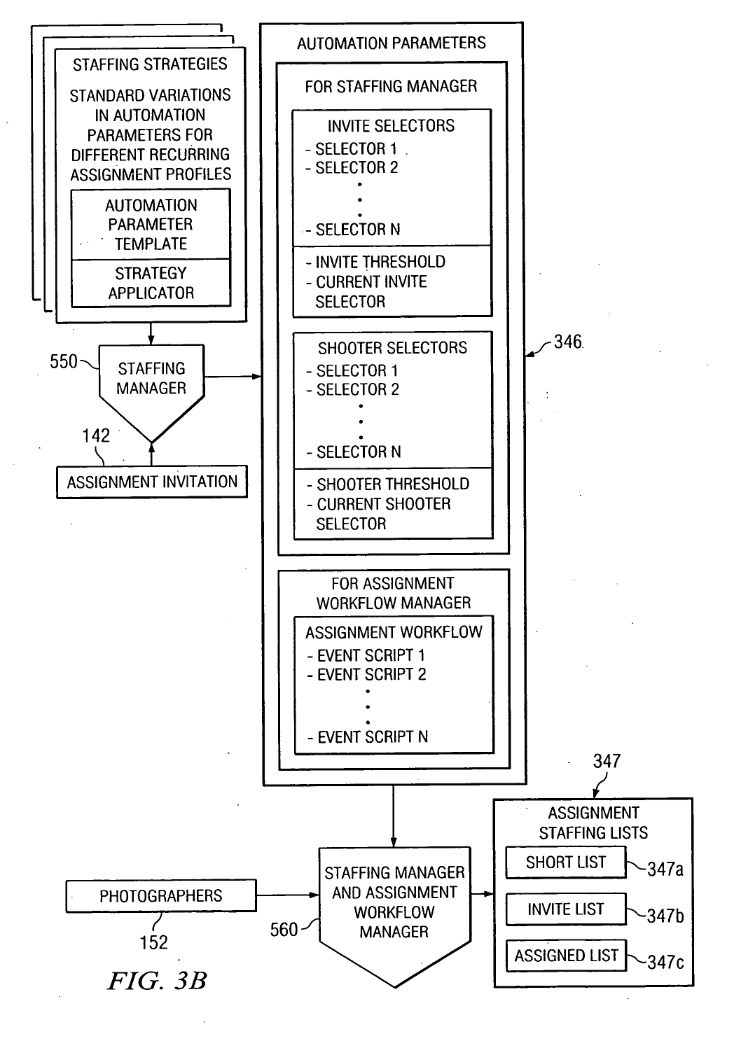

In addition, domain data 305 may also include site data 360. In certain embodiments, site data 360 contains system-wide property data. For example, system-wide property data contained in site data 360 may comprise: (1) template strategies for automation parameters, (2) template content for automation notifications, (3) system-wide parameters for selective enabling and disabling of automation and notification functions, system configuration parameters such as active image storage, available image storage, and active servers, and (4) history and error logs. Automation parameters are discussed in more detail with respect to FIG. 3A.

2. Images

Data layer 300 also includes images 370. In certain embodiments, images 370 may comprise files of varying formats, such as TIFF and JPG, that contain an actual picture, and may, depending upon the format, contain metadata. Metadata is data that may be inserted by a program used to capture and edit an image, such as a digital camera or image editing software applications. Images 370 may include images 158, 162, 163, 164, and/or 172. Images 370 may be stored as files in large file servers. In certain embodiments, images 370 may contain two types of images. For example, images 370 may contain original images 380. Original images 380 may include upload images 158, 163, which have been uploaded by the photographers as submissions in response to an assignment based on the photographer assignment invitation or as “stock” photo submissions,

In addition, images 370 may also include processed images 390. Processed images 390 are those images that that have undergone processing by various elements of system 100, such as image processors. For example, each image 158, 163 may have a processed version that is used for analysis or presentation of the corresponding original image 380 by various audiences, through various interfaces, and for various purposes. Examples of processed images 390 may include thumbnail images, medium resolution images, and medium-high resolution versions of images 380 that are designed for efficient display in the various interfaces 400 of system 100.

II. The Interface Layer

Computer architecture 200 also includes interface layer 400. Interface layer 400 includes the numerous interfaces that are presented to the various users of system 100. In certain embodiments, interface layer comprises external interfaces 402 and internal interfaces 420. External interfaces 402 may include a photographer interface 405 and a customer interface 415. Internal interfaces 420 may include a sales interface 430, an assignment editing and staffing interface 440, an image editing interface 450, a photographer management interface 460, an administration interface 470, a stock image processing and key-wording interface 480, and a stock image search interface 490. Each interface contained in interface layer 400 may comprise a graphical user interface (GUI) operable to allow the user of system 100 to interact with one or more processes executing by system 100. Generally, the interfaces in interface layer 400 provides the user of system 100 with an efficient and user-friendly presentation of data. Each interface may comprise a plurality of displays having interactive fields, pull-down lists, and buttons operated by the user. In one example, each interface may present an explorer-type interface and receive commands from the user. Further, each interface contemplates any graphical user interface, such as a generic web browser, that processes information on system 100 and efficiently presents the information to the user.

The interfaces in interface layer 400 may contain recurring paradigms found in all, none, or some of the interfaces. For example, in certain embodiments, at least some of the interfaces in interface layer 400 may comprise a lightbox. A lightbox is a screen that contains a tiling of small images called thumbnails (usually from 9 to 16 thumbnails per page). The thumbnails are small processed versions (images 390) of the original uploaded image 158, 163, 380. Public lightboxes are available to external users, such as customers 102 or the photographers, and allow the users to select a thumbnail image and see a medium resolution image on the order of 640×480 pixels. Internal lightboxes will allow users to select a thumbnail and get a medium-high resolution version of the image (usually between 1024 and 2048 pixels wide).

All lightboxes support paging, allowing users to go from one page of images to another page of images or to flip directly to a specific page. Depending on the lightbox use, different sets of annotation data are displayed under each thumbnail. Many of the interfaces in interface layer 400 display lists, some of which may be very long. In general, any interface that may return a large set of data can be paged. Paged interface screens show a subset of the entire data set and allow users to page through the data sequentially or by jumping to a specific page.

Each interface in interface layer 400 is defined around user roles. Each user may have one or more roles relative to system 100. For example, a user of system 100 may be image editor 160 in one role, while also acting as the stock editor 170. When a user logs into system 100, his role defines which of the interfaces in interface layer 400 they can see and use. Roles are fixed for photographers and customers 100 and, in general, do not change. Internal users of system 100, such as sales person 130, assignment editor 140, image editor 160, and stock editor 170, have roles that are defined by a system administrator through administration interface 470, described below.

1. Photographer Interface

In certain embodiments, photographer interface 405 is composed of an agreement sub-interface 405a, a profile sub-interface 405b, an assignment sub-interface 405c, and an images sub-interface 405d. Agreement sub-interface 405a presents a contract to a photographer that defines the terms of their work. Each photographer must accept this agreement before they can access any other function of photographer interface 405. Once the contract is accepted by the photographer, system 100 records the acceptance and thereafter the photographer no longer sees agreement sub-interface 405a unless the terms of the contract require the photographer to review, reaccept, or otherwise renew their acceptance of the contract.

Profile sub-interface 405b is used by a photographer to create and maintain a photographer profile describing the photographer. Profile sub-interface 405b allows for the creation of profile data for new photographers and for updating and/or changing profile data for existing photographers. Profile sub-interface 405b comprises a basic form where the photographer may specify general information about themselves, for example their name, location, and contact information. A second section of the photographer profile comprises a set of questions specific to the photographer's skills and capabilities. An example profile sub-interface 405b is illustrated in FIG. 5A

Returning to FIG. 2, assignment sub-interface 405c provides many functions, such as listing assignments a photographer has been invited to (assignment invitations 142), listing assignments a photographer has been assigned to (an active assignment), listing assignments a photographer was assigned to in the past (a past assignment), showing detail on any assignment including a mixture of text and images that describe the assignment, and allowing photographer to decline an assignment and/or request that he be assigned to an invited assignment. Assignment sub-interface 405c comprises two views. The first view lists invited, active, and past assignments associated with a photographer. The second view is a detailed view of an individual assignment, where the information entered and edited by sales persons 130 and/or and assignment editor 140 may be reviewed by a photographer. FIGS. 5B-5D illustrate example screens of assignment sub-interface 405c. FIG. 5B illustrates an example view presented to a photographer of his assignment invitations 142. FIG. 5C illustrates an example view presented to a photographer of the detail of a specific assignment invitation, including the ability to either Decline or Request Signup for the assignment. FIG. 5D illustrates an example view presented to a photographer of his active assignments.

Returning to FIG. 2, images sub-interface 405d displays a lightbox of thumbnails showing a photographer all of the images they have submitted to an assignment. In addition, for active assignments, images sub-interface 405d allows a photographer to upload additional images 158 and submit them to image editor 140 for consideration. In certain embodiments, images sub-interface 405d allows a photographer to upload scans or photographs of signed rights release contracts (called release images and described in more detail below) and to associate these release images with the submitted assignment images to which they apply. Each active and past assignment may have an associated images sub-interface 405d. FIG. 5E illustrates an example view of images sub-interface 405d during uploading of an image 158 for submission to an assignment.

In certain embodiments, images sub-interface 405d allows a photographer to upload images 163 for submission to a stock editor for possible acceptance into stock image library 180.

2. Customer Interface

Customer interface 415 is similar in structure to photographer interface 405. In certain embodiments, customer interface includes a profile sub-interface 415a, an assignment sub-interface 415b, and an image sub-interface 415c. Profile sub-interface 415a allows a customer 102 to manage general information about themselves, such as name and contact information. Profile sub-interface 415a allows general profile data to be entered for new customers 102 in addition to allowing editing/changing of profile data for existing customers 102.

Assignment sub-interface 415b provides both a summary and a detail view of assignments associated with each customer 102. The assignments shown are only those associated with the specific customer 102 who has logged into system 100. Assignment sub-interface 415b provides numerous functions to customer 102. For example, a customer 102 may view a list of all his ongoing assignments (the active assignments), view a list of all completed assignments (the past assignments), and/or create a customer order 114 for a new assignment by specifying a detailed description of the image that customer 102 wants and how the image will be used.

Each assignment has an image sub-interface 415c that may display a lightbox of thumbnails showing all approved images 162 that are ready for viewing by customer 102. Image sub-interface 415c may also allow a medium resolution version of each image 162 to be displayed for more detailed consideration by customer 102. Upon reviewing images 162 in the lightbox, customer 102 may contact sales person 130 and obtain a license to use one or more images. Images for which customer 102 has obtained a license to use will appear in the image sub-interface 415c in a separate “licensed” lightbox where the associated original high-resolution image 380 may be downloaded by the customer and used in accordance with the license obtained from sales person 130. FIG. 5F illustrates an example of the lightbox portion of image sub-interface 415c, which allows customer 102 to see the set of approved images 162 for a particular assignment.

As discussed above, interface layer 400 includes internal interfaces 420. In certain embodiments, internal interfaces 420 may include sales interface 430, assignment editing and staffing interface 440, image editing interface 450, photographer management interface 460, administration interface 470, stock image processing and key-wording interface 480, and stock image search interface 490. Internal interfaces 420 are used by system 100 to manage the interaction between photographers and customers 102. Each interface in internal interfaces 420 is organized around a particular job role.

3. Sales Interface

In certain embodiments, sales interface 430 includes a sales contact management sub-interface 430a and a sales order sub-interface 430b. Sales contact management sub-interface 430a allows a user to create, update, and delete profiles for new customers 102. Sales contact management sub-interface 430a also allows a user to create, update, and delete customer contacts including profile data that describes each customer 102 contact, and to create, update, and delete customer 102 logins for access to customer interface 415.

Sales order sub-interface 430b allows a user to create a new project. A project is similar to a folder in which a group of related customer 102 orders can be organized. Sales order sub-interface 430b may also allow a user to create sales order 132 for a customer assignment. As discussed above, sales order 132 may include all of the information that describes what image customer 102 wants (the assignment invitation), for example, but not limited to, settings, models, and/or lighting. Sales order 132 also includes information about how the image will be used (the license terms) and what the customer 102 will pay if an acceptable image is delivered (the license fee). Sales order sub-interface 430b also allows a user to copy a customer order 114 to create initial sales order 132. This allows sales person 130 to edit an order that was directly entered by the customer 102 using the customer assignment sub-interface 415b. For example, customer information may be copied and then modified by sales person 130 and then accepted as a sales order 132. Therefore, the original customer data is preserved, but sales person 130 is allowed to fill in gaps or otherwise annotate a customer's request. Sales order sub-interface also allows a user to view the current customer image lightbox and to license an image in the lightbox, enabling the original high-resolution image to be downloaded by customer 102. FIG. 5G illustrates an example view of sales order sub-interface 430b.

4. Assignment Editing & Staffing Interface

Returning to FIG. 2, in certain embodiments assignment editing and staffing interface 440 comprises three main sub-interfaces, an arrival sub-interface 440a, an assignment editing sub-interface 440b, and a staffing sub-interface 440c. Arrival sub-interface 440a comprises a current activity section that shows a list of sales orders 132 and photographer assignments 142 in process. Status and summary data are shown for each sales order 132 and photographer assignment 142 in process, allowing internal users to decide what activity to work on. Arrival sub-interface 440a also includes a past assignments section which shows a list of closed assignments in summary form.

Assignment editing sub-interface 440b allows a user to copy a sales order 132 to create an initial photographer invitation 142. This allows the user to edit the assignment invitation to ensure that the invitation is in a form that the photographer can understand (“photographer-speak”), thereby ensuring that the assignment that will be presented to the photographer is clear and contains all of the information required to effectively shoot images that will satisfy customer 102. Assignment editing sub-interface 440b also allows users to define any internal parameters for controlling the automated staffing of an assignment and its workflow execution by staffing and assignment workflow managers 550, 560, as discussed in more detail below.

Assignment editing sub-interface 440b also allows a user to edit or change an existing photographer assignment to make corrections or further refine the description of what the customer 102 wants and to change the state of an assignment. For example, valid assignment states include: (1) “pending”—the assignment is not yet visible to photographers: (2) “active”—the assignment is visible to a photographer and images submissions are accepted; (3) “not accepting submissions”—the assignment is visible to the photographer but no submissions are being accepted; and (4) “closed”—the assignment is no longer active and it has been moved to the past assignments list for all audiences (photographer, customer 102, and internal users).

Staffing sub-interface 440c is used to assign a photographer to an assignment. Sub-interface 440c is based on the staffing process and the concept of strategies, as described in more detail below. Staffing sub-interface 440c allows for manual or automated identification of a set of photographers most likely to succeed in delivering an image to customer 102 and for manual or automated assignment invitation delivery to a photographer. Staffing sub-interface 440c also allows an internal user to review a photographer's responses to an invitation 142 and the manual or automated rejection/assignment of photographer requesting to be added to a list of active assigned photographers 156 for a given assignment. FIGS. 5H-5J illustrate examples of staffing sub-interface 440c as used for manual staffing of an assignment. FIG. 5H illustrates an example of sub-interface 440c used by assignment editor 140 to search for photographers based on the information in their profiles and the requirements of the assignment. FIG. 5I illustrates an example of sub-interface 440c used by assignment editor 140 to view the group of photographers that have been sent assignment invitations for a given assignment. FIG. 5J illustrates an example of sub-interface 440c used by assignment editor 140 to view which photographers have requested to signup for an assignment. The sub-interface illustrated in FIG. 5J is also used by assignment editor 140 to create the final list of assigned photographers 156.

5. Image Editing Interface

Returning to FIG. 2, in certain embodiments, image editing interface 450 includes an arrival sub-interface 450a and an image staging sub-interface 450b. Arrival sub interface 450a is similar to arrival sub-interface 440a associated with assignment editing and staffing interface 440. Arrival sub-interface 450a includes a current activity section, which shows a list of active photographer assignments. In some embodiments, status and summary data is shown for active photographer assignment, allowing users to decide which assignment to work on. Arrival sub-interface 450a also includes a past assignments section which shows a list of closed assignments in summary form.

Image staging sub-interface 450b allows image editor 160 to review the submitted images 158 for each assignment shown in arrival sub-interface 450a. Images 158 can be rejected, approved for customer viewing (approved images 162), or parked and held until a later date. In certain embodiments, image staging sub-interface 450b includes five lightboxes, discussed in more detail below with respect to FIG. 4A, which may display collections of thumbnail images. For example, image staging sub-interface 450b may include a “staged lightbox” that shows newly uploaded images 158 for a given assignment, a “rejected lightbox” that shows the uploaded images 158 that were rejected by image editor 160 and, therefore, are not accessible to customers 102, an “approved lightbox” that shows approved images 162 that are available for viewing by customer 102, a “parked lightbox” that shows the uploaded images 158 that image editor 160 has decided to hold in waiting for other purposes or for later review, and a “releases lightbox” that contains the release images associated with the images in all other lightboxes. Each lightbox allows uploaded images 158 to be selected and moved to one of the other lightboxes. Any image 162 in the “approved lightbox” can be seen by customer 102 through customer interface 415. FIG. 5K illustrates an example view of image staging sub-interface 450b, which displays uploaded images 158 to image editor 160 for approval or rejection.

In addition to sorting uploaded images 158 into one of the five lightboxes described above, image staging sub-interface 450b allows image editor 160 to mark any uploaded image 158 that should be considered as a possible stock image (selected images 164). Selected images 164 are thereafter made available to stock image processing and key-wording interface 480, described in more detail below.

In certain embodiments, image editing interface 450 may be used to manage release document scans and images (release images) and to associate release images with their corresponding images. Release management and association is discussed in more detail below.

6. Photographer Management Interface

Referring again to FIG. 2, in certain embodiments, photographer management interface 460 may include an active photographer sub-interface 460a, an invited photographer sub-interface 460b, a pending photographer sub-interface 460c, and a photographer profile sub-interface 460d. Active photographer sub-interface 460a is modeled after a search/search result paradigm. Active photographer sub-interface 460a allows assignment editor 140, or other internal user, to search a set of photographers that have accepted agreement terms presented by photographer agreement sub-interface 405, discussed above, and who are now candidates for an assignment invitation 142. Active photographer sub-interface 460a provides the ability for assignment editor 140 to search for an active photographer by specifying a set of search criteria, to sort the search results, and to update/change a photographer, as discussed below with reference to photographer profile sub-interface 460d.

In certain embodiments, invited photographer sub-interface 460b is similar to active photographer sub-interface 460a except that sub-interface 460b limits it searching to the set of photographers in photographer network 152 that have not yet accepted the agreement terms for participation as assignment shooters. More detail regarding the distinction between invited photographers and active photographers is discussed below with reference to photographer manager 510 of business layer 500. Invited photographer sub-interface 460b allows assignment editor 140 to search for an invited photographer by specifying a set of search criteria, sort the search results, delete photographers, update/change a photographer using photographer profile sub-interface 460d, and to add a new invited photographer.

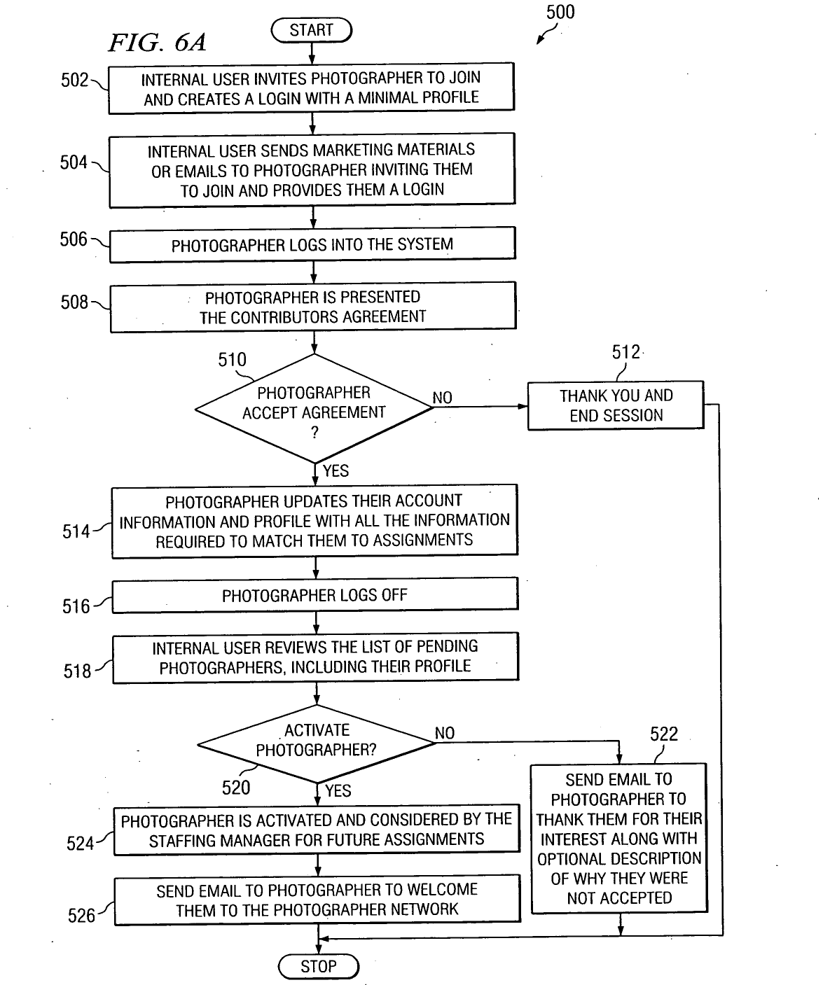

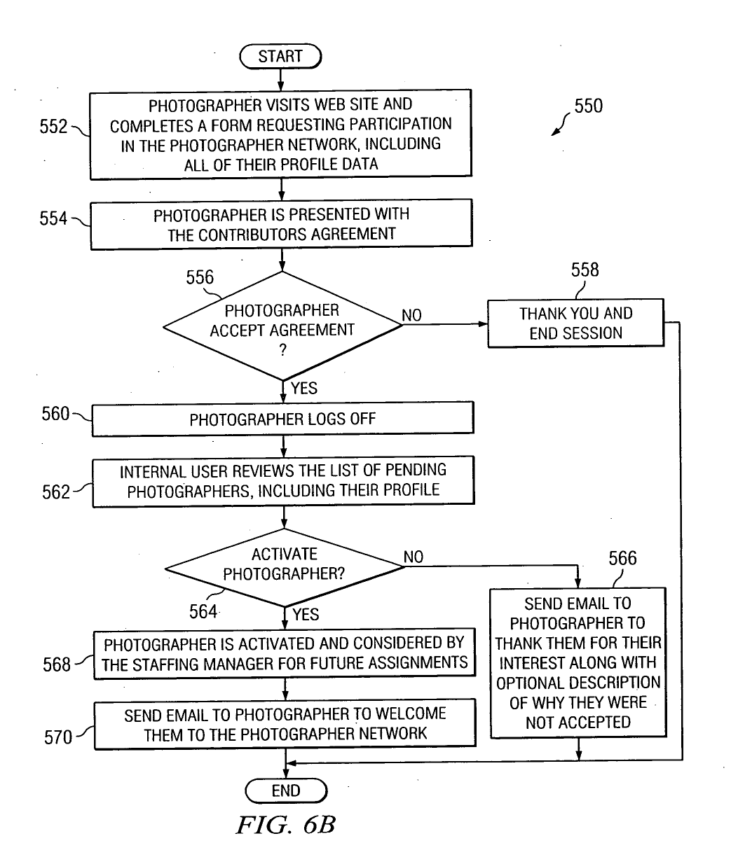

Pending photographer sub-interface 460c allows a user to review a summary list of photographer, similar to a work queue, who have requested to join network 150 (but have not yet accepted the agreement), and then either approve those photographers to join network 150, or reject the photographers based on the data they provide in their application form. Once approved, the photographers move to active photographer sub-interface 460a and can participate in assignments. FIGS. 6A-6B, discussed in detail below, illustrate example methods for adding a photographer to photographer network 152.

Photographer profile sub-interface 460c provides access to a photographer profile including those attributes visible to a photographer and any internal profile attributes such as photographer rating data, discussed in more detail below. Photographer profile sub-interface 460c. allows an assignment editor to specify profile attributes for a new invited photographer and update/change photographer profile attributes.

7. Administration Interface

Administration interface 470 is used by a system 100 administrator to add and manage internal users of system 100 and to manage the set of properties for overall system 100 behavior. In certain embodiments, administration interface 470 includes an arrival sub-interface 470a, an internal user profile sub-interface 470b, and a systems properties sub-interface 470c. Arrival sub-interface 470a shows a list of active internal system 100 users. These are the users that can log into one or more internal interfaces 420, such as sales persons 130, assignment editors 140, image editors 160, stock editors 170, and/or any other appropriate internal users of system 100. Arrival sub-interface 470a allows an administrator to delete an internal user and to add or update information associated with an internal user using internal user profile sub-interface 470b.

Internal user profile sub-interface 470b provides access to the detailed profile information of internal users, which may include attributes such as name, password, and security privileges. Internal user profile sub-interface 470b allows an administrator to specify profile attributes for new internal users in system 100 and to update/change the profile attributes of an existing internal user.

System properties sub-interface 470c allows administrators of system 100 to control the overall system behavior by changing global properties that affect the way system 100 behaves as a whole. For example, an administrator can enable or disable certain types of email notifications system 100 may automatically send as a result of the occurrence of particular events. System properties sub-interface 470c may display current global system 100 property values and allow an administrator to update/change global system 100 properties.

8. Stock Image Processing and Key-Wording Interface

Stock image processing and key-wording interface 480 comprises an image work queue. The queue is displayed using a lightbox interface paradigm consisting of thumbnail images of images 163, 164. Images 164 are added to the end of the queue when image editor 160 marks an uploaded image 158 as a potential stock image 164 using image editing interface 450. Images 163 are added to the end of the queue when the photographer submits an image 163 to stock editor 170 for consideration as a stock image. Alternatively, an image may be imported from an external source, such as a CD-ROM, as a candidate stock image 163, 164. In certain embodiments, as each image 163, 164 in the queue is selected by stock editor 170 for review, stock editor 170 will process image 164 by either rejecting image 163, 164, removing it from the work queue, or accepting image 163, 164. If image 163, 164 is accepted, stock editor 170 reviews the annotations related to image 163, 164, such as its caption, and then files key-worded image 172 in stock image library 180 for use in future image searches. The process of key-wording image 163, 164 to create key-worded image 172 includes selecting a set of relevant and commonly used keywords associated with the content of image 163, 164, which will be used to locate the image in a search through stock image search interface 490, described below. Once key-worded and reviewed, image 164 (which is now key-worded image 172) is accepted and removed from the work queue.

9. Stock Image Search Interface

Stock image search interface 490 comprises a search/search result paradigm. In certain embodiments, the initial screen of stock image search interface 490 includes a list of image attributes, such as keywords used in the search. The result is a search against a set of key-worded images 172, filed by stock image processing and key-wording interface 480, as discussed above. Search results are displayed as a lightbox of small thumbnail images. Selecting an image thumbnail returns a medium resolution version of image 172 for review. If a user, such as assignment editor 140, determines that image 172 meets the requirements of a particular customer 102 assignment, image 172 may be submitted to the approved lightbox of that assignment.

III. The Business Layer

Computer architecture 200 also includes business layer 500 which contains a set of functional components. In certain embodiments, the functional components, referred to as “managers,” of business layer 500 include a photographer manager 510, a customer manager 520, an internal user manager 530, a project/assignment manager 540, a staffing manager 550, an assignment workflow manager 560, an image processing manager 570, a image manager 580, a stock manager 590, and a license manager 600.

Domain data is captured through the interfaces of interface layer 400 from users of system 100 and is stored in one or more of the databases and/or files of data layer 300. Creation, Reading (or query), Update, and Deletion (C.R.U.D.) of this data is a recurring and basic function of business layer 500. All of the managers described below implement some form of C.R.U.D. data manipulation, in addition to the more complex business logic and processes described below. The following discussion defines the function of each manager and the key processes involved in making system 100 work.

1. Photographer Manager

Photographer manager 510 is responsible for managing the set of photographers forming photographer network 152 of system 100. Photographer manager 510 includes general C.R.U.D. functionality for photographer domain data. In certain embodiments, photographer manager 510 controls the addition of new photographers into photographer network 152 of system 100 and the rating of those photographers.

New photographers may be added to photographer network 152 using two different methods. In the first method, discussed below as method 500 of FIG. 6A, a photographer is recruited to join photographer network 152 by an internal user of system 100, such as assignment editor 140. In the second method, discussed below as method 550 of FIG. 6B, a photographer may visit a web site associated with system 100 and join photographer network 152 without first being invited by an internal user of system 100.

Referring again to FIG. 2, photographer manager 510 also controls the rating of the photographers who are members of photographer network 152. Each photographer in photographer network 152 has a set of ratings. In certain embodiments, a rating is an number where a zero value is associated with a “neutral” rating, a positive value is associated with a “good” rating, and a negative value is associated with a “poor” rating. The higher the rating, the better the photographer has performed in the particular rating category. When a photographer is activated, as described with reference to FIGS. 6A-6B, each photographer's ratings may be initialized to zero, or “neutral.” As each photographer interacts with system 100, their ratings are adjusted either automatically or manually to track their aggregate performance. Rating data is used by staffing manager 550, discussed below, to select and staff appropriate photographers to assignments.

An alternate initialization technique initializes ratings based on the initial profile provided by a photographer. In this particular method, ratings are initialized to either “neutral” or slightly “positive” to reflect the claimed abilities of a photographer, thereby allowing more intelligent staffing of new photographers. The bias that each photographer receives in rating initialization, however, is only slight, so that other photographer-earned rating changes are rated higher than those who claim to have a certain level of ability.

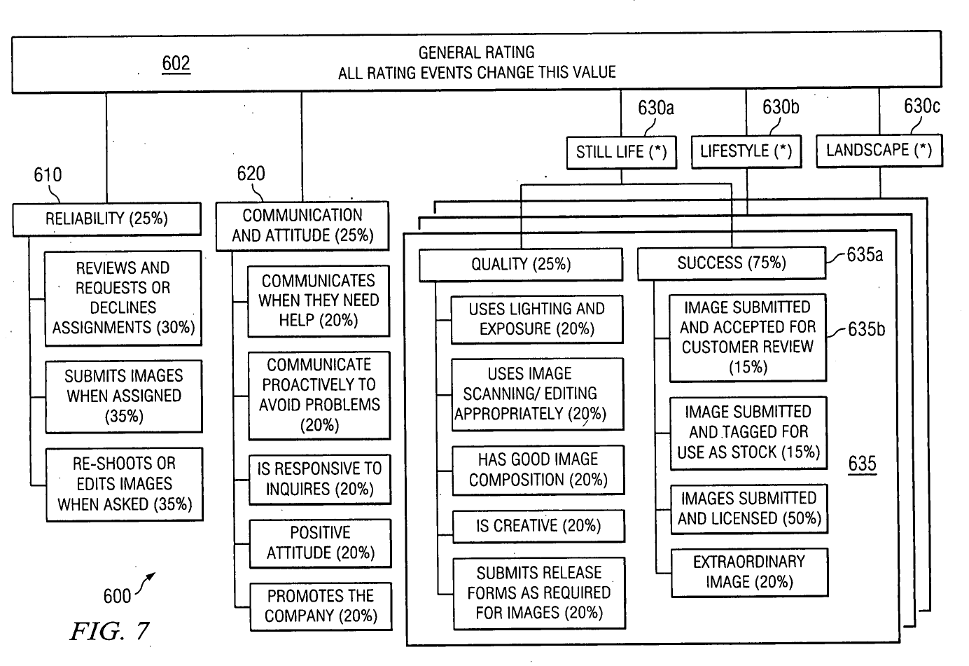

Photographer rating changes are aggregate, meaning there is no upper or lower bound to their values. This allows rating values to have continued meaning over a long duration of time. More tenured and higher performing photographers will always have the highest ratings. In certain embodiments, photographer ratings types and calculations are illustrated below with respect to FIG. 7 and TABLES 6-7.

2. Customer Manager

Customer manager 520 is responsible for managing the set of organizations and customers 102 utilizing system 100. Customer manager 520 implements general C.R.U.D. functionality for customer domain data. This includes the ability to create new customers and new users within those customers. It also includes the ability to update the profile of customers and their users.

3. Internal User Manager

Internal user manager 530 is responsible for managing the set of internal users, such as sales persons 130, assignment editors 140, image editors 160, and stock editors 170, in system 100. Internal user manager 530 includes general C.R.U.D. functionality for internal user domain data. This includes the ability to create new internal users or to update the profile of existing internal users. Internal user manager 530 is also responsible for understanding the organizational structure of internal users, such as who reports to who. In certain embodiments, it groups sets of internal users together into groups, which are used to manage the ownership and flow of data in the system. For example, but not by way of limitation, an internal user who has subordinates may have the right to view the data (assignments, customers, photos, etc) of their subordinates. Another example of group usage is for work groups. A new sales order is submitted to assignment editor 140 for review and staffing. A group may be formed and the assignment is submitted to the group, rather than to a specific individual. In this manner, all members of the group have visibility and access to each other's data and can thereby help out by doing the work if a member of the group is unavailable to complete a task.

4. Project/Assignment Manager

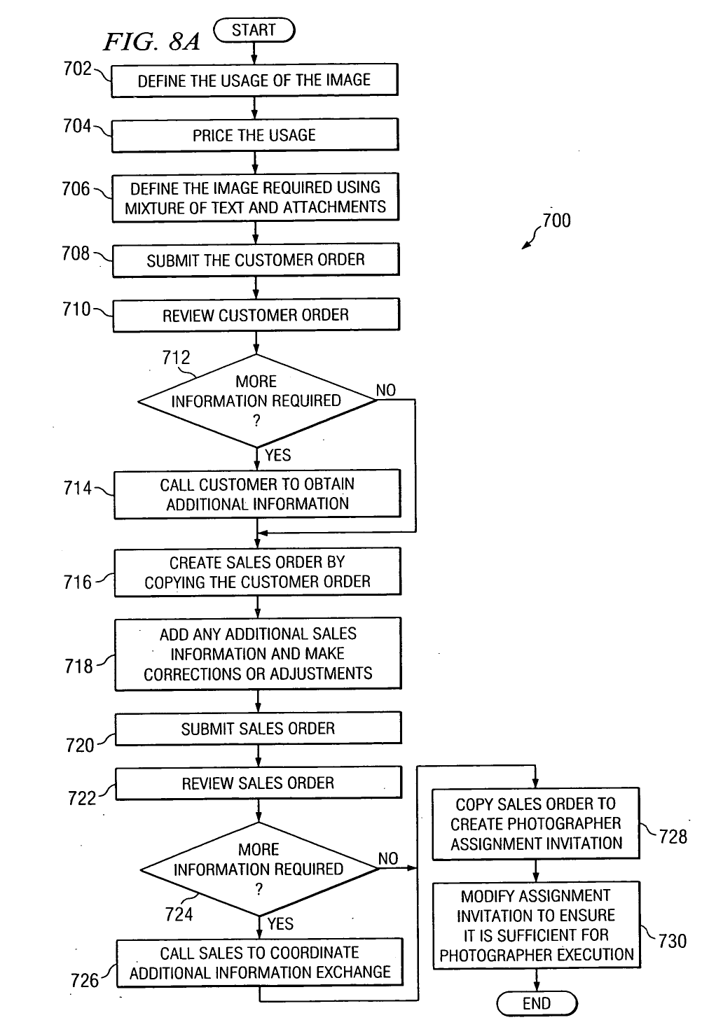

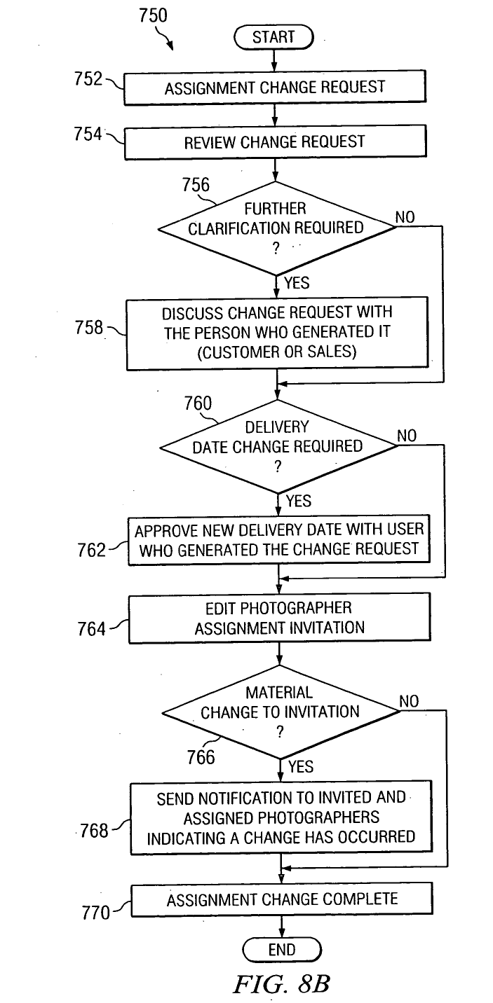

Project/assignment manager 540 is responsible for managing all assignments in system 100. Manager 540 controls the creation of new photography assignments described below with reference to FIG. 7A. Once project/assignment manager 540 has completed the creation of a new photography assignment, staffing and assignment workflow managers 550, 560, described below, execute the assignment invitation generated by manager 540. Manager 540 may also control the process of changing a photography assignment, described below with reference to FIG. 8B. Photography assignment changes may come from several sources. For example, customer 102 may change or refine the assignment description, usually after reviewing an initial set of approved images through customer interface 415. Customer 102 may communicate this information to salesperson 130 or directly to assignment editor 140.

In addition to the creation and modification of photography assignments, in certain embodiments, project/assignment manager 540 also controls the process of pricing a requested image. The pricing process is used by customers 102 and sales persons 130 to price the usage of a desired image. Image usage is defined by a set of “pricing properties” which contain one or more values that are pre-defined, allowing a set matrix to be defined for price calculation. The number and valid values of pricing properties may vary depending upon the particular image desired. For, example, but not by way of limitation, manager 540 may price an image based on pricing properties such as: (1) the type of image usage, such as an advertisement, a brochure, a presentation, or a publication; (2) the specific industry where image use will occur and be restricted to; (3) the estimated number of people to which a use of the image will be circulated; (4) the size of the image when used in a printed format; (5) the number of times the circulation audience will have an opportunity to view the image (referred to as “total insertions”); (6) the duration of the image license; and (7) the geographic locations where the image will be used. Although specific pricing properties are illustrated, any appropriate image pricing property may be used to determine an image price. In some embodiments, image pricing properties may be substantially similar between industry competitors, thereby allowing image pricing to be competitive.

The complexity of the price calculations implemented by manager 540 may be a variable. However, in certain embodiments, the baseline implementation of pricing may comprise a simple table lookup stored in a database of data layer 300, such as project and assignment data 340, using the pricing properties as a multi-dimensional index from which to determine the baseline price for an image. This baseline price may be offered to a customer 102 or it may be discounted by an internal user of system 100, such as sales person 130. In addition to the basic usage price, customers 102 may desire exclusive use of the image (also called protection). This means that customers 102 wish to ensure the same image cannot be sold for a competitive use, thus protecting their investment in using system 100 to produce a custom stock image, such as images 162. The exclusivity of an image license may be negotiated by sales person 120 on a case-by-case basis, with the “exclusivity fees” added to the baseline image price to result in the total image price.

5. Staffing Manager

Staffing manager 550 controls the general process of assigning a pre-defined number of qualified photographers 156 to submit images for a specific assignment, whether the images previously exist or are shot on demand. Photographers 156 have reviewed the requirements for the assignment and have committed themselves to submit qualified images in the specified timeframe. Staffing begins when customer 102 gives permission to activate an assignment and ends where one or more photographers 156 have agreed to submit images, which meet the assignment requirements.

The general process of staffing an assignment is performed by two actors and two system managers. The actors are the assignment editor 140 and the photographers 152. Assignment editor 140 edits the assignment to create the photographer assignment invitation, then configures the staffing strategy to be used for staffing, and begins the staffing process. Assignment editor 140 is also responsible for handling situations where fully automated staffing is not sufficient and the assignment editor is required to manually select photographers for the assignment. The photographers review the photographer assignment invitations for assignments to which they have been invited to participate in. The photographers may then either request signup to an assignment or decline to shoot an assignment.

The system managers involved in the staffing process are staffing manager 550 and assignment workflow manager 560. Staffing manager 550 is responsible for the invitation of photographers to assignments, processing the photographer responses, and selecting the set of photographers who will be ultimately assigned to shoot the assignment. Staffing manager 550 works in close collaboration with assignment workflow manager 560. Staffing manager 550 is a passive manager, in that it responds to either manual interaction from assignment editor 140 who is using staffing interface 440, or from automated commands issued from assignment workflow manager 560. Staffing manager 550 in effect acts as a command interface in that it receives a command, processes it, and may produce a result.

Assignment workflow manager 560, which is discussed in more detail below, is an active manager that responds to events, including those based on the passing of time, to execute scripts that evaluate the status of assignment staffing and modify staffing parameters to improve the ability of staffing manager 550 to successfully staff the assignment. Assignment workflow manager 560 is also responsible for detection of conditions where an assignment editor 140 should intervene to manually solve a staffing problem. Although the majority of workflow managed by assignment workflow manager 560 relates to staffing an assignment, as described below, assignment workflow manager 560 is responsible for the active monitoring and management of an assignment throughout and beyond staffing.

Staffing begins at the end of the new assignment process. Assignment editor 140 at this point has modified the photographer assignment invitations so that they are ready to be presented to the candidate photographers in photographer network 152. Using staffing sub-interface 440c, assignment editor 140 configures a set of parameters that will control the staffing process. These parameters are referred to as automation parameters. The assignment is then activated. At this point assignment workflow manager 560 is notified that staffing has begun and the workflow for controlling and monitoring that staffing executes.

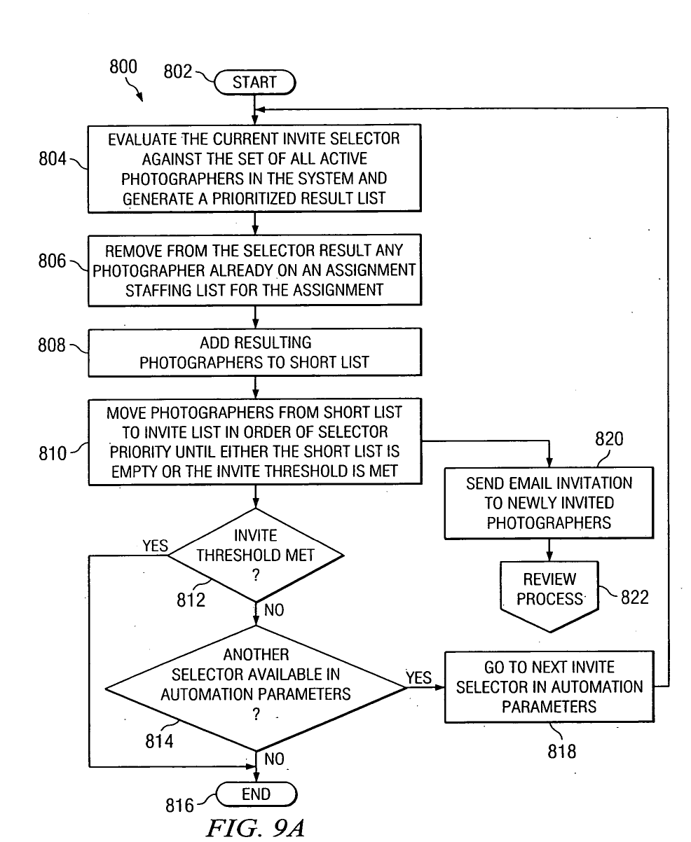

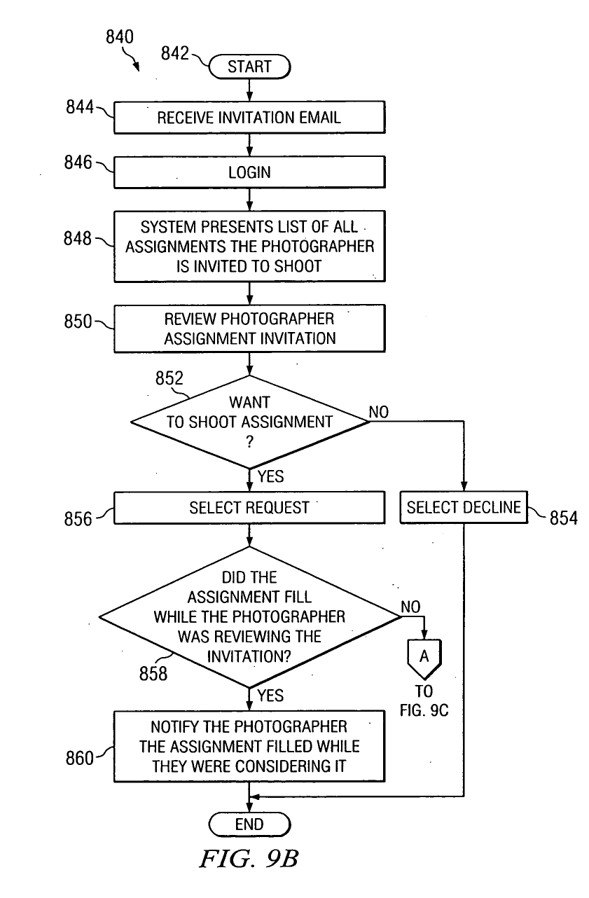

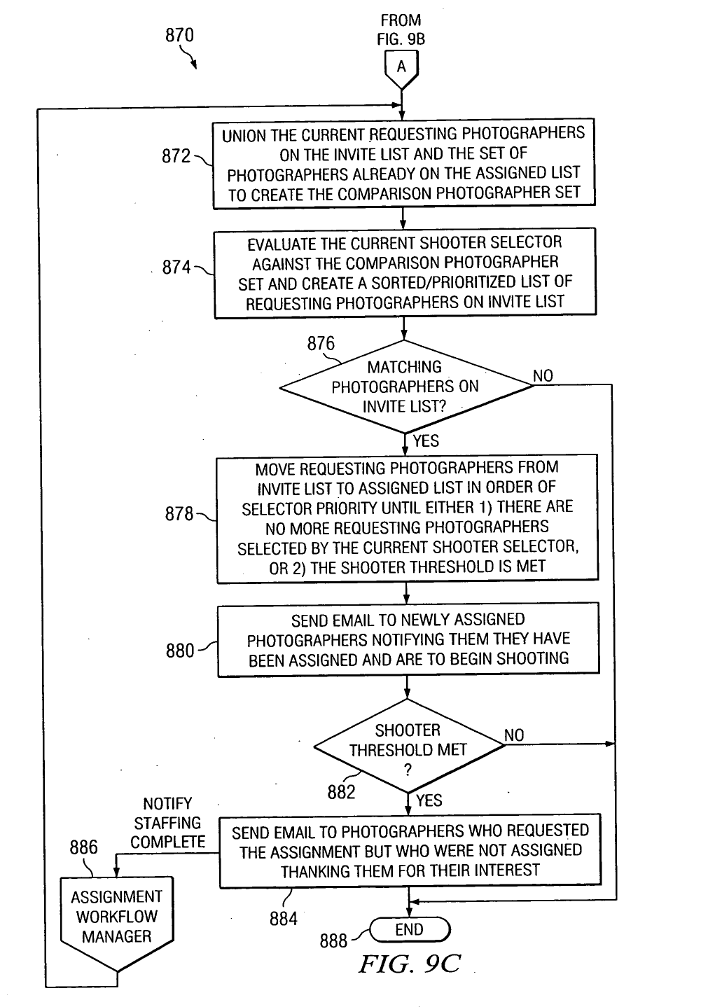

FIG. 3A illustrates an example relationship between staffing manager 550 and assignment workflow manager 560 when they cooperate to staff an assignment. Staffing manager 550 can be divided into an invitation process 800, a review process 840, and an assignment process 870. In general, invitation process 800 is the process of locating and inviting a set of photographers to review the assignment. Review process 840 is the process whereby each invited photographer reviews an assignment invitation which contains the photographer assignment invitation and either requests to signup to the photo shoot or declines to shoot the assignment. Assignment process 870 is the process where a subset of the photographers who have requested to signup to the photo shoot are actually assigned to the assignment, after which they are allowed to submit images. Processes 800, 840, and 870 are described in more detail below with respect to FIGS. 9A-9C. In certain embodiments, assignment workflow manager 560 has little involvement in the staffing process. When assignment editor 140 activates the assignment, invitation process 800 invites an acceptable set of candidate photographers. Then, it is assumed that enough of these candidate photographers will request signup to the photo shoot so that assignment process 870 is able to select the optimal team of assigned photographers 156. Assignment workflow manager 560 is then notified staffing is complete. All of this happens within an acceptable period of time, requiring little, if any, manual or workflow initiated intervention.

In other embodiments, assignment workflow manager 560 may initiate an escalation to staffing manager 550. Escalation is discussed in more detail below, but in general escalation can take the following forms: (1) “invite threshold escalation”—where additional photographers are invited to review the assignment (invite process 800 may automatically change the criteria used to select the candidate photographers for invitation, if necessary); (2) “shooter selection escalation”—where either the number of required final assigned photographers 156 is reduced or the criteria used to select the final assigned photographers 156 from those photographers who have requested signup to the photo shoot is changed; (3) “restart”—where another strategy for staffing is selected and the staffing process is restarted; and (4) “alarm”—where an alarm is sent to assignment editor 140 for manual intervention in the assignment process.

FIG. 3B illustrates an example staffing data flow. In certain embodiments, fives sets of data may be used in staffing. Two of these data sets have been described previously—the photographers (including their detailed profiles) and the photographer assignment invitations. The other three sets of data are the staffing strategies, the automation parameters, and the assignment staffing lists. Assignment editor 140 uses staffing manager 550 to configure the automation parameters for the staffing. This process may be template driven. Each template for the automation parameters is called a “staffing strategy.” These templates can extract data from the photographer assignment invitations to create a set of initial automation parameters. The automation parameters are further specified or modified by assignment editor 140 and the assignment is activated. The automation parameters control the staffing processes and the interaction of staffing manager 550 and assignment workflow manager 560. Together, managers 550, 560 work to move the best possible set of qualified photographers onto the assigned list (which contains a listing of assigned photographers 156), at which point assigned photographers 156 have committed to shoot the assignment and submit images 158.

In certain embodiments, each assignment has three persistent assignment-staffing lists 347a-347c of photographers. An individual photographer can only be a member of one assignment staffing list 347 at any one time. A photographer may move from one assignment staffing list 347 to another, but will not be present on more that one assignment staffing list 347 at a given time. The three persistent assignment staffing lists include the short list 347a, the invite list 347b, and the assigned list 347c. Short list 347a contains the list of photographers (taken from the pool of all photographers in photographer network 152) that meet the minimum requirements for shooting the assignment and are candidates to be staffed. Photographers on short list 347a may be moved to invite list 347b. A photographer on invite list 347b is invited to participate in the assignment and is sent an assignment invitation 142. Each invited photographer must respond, via photographer interface 405, to the invitation by either requesting signup to the photo shoot or declining to participate in the photo shoot. Photographers on invite list 347b that request signup to the photo shoot may be moved to assigned list 347c, which contains a listing of assigned photographers 156. A photographer on assigned list 347c has committed and been accepted to shoot the assignment. Assigned photographers 156 may upload and submit images 158 for consideration by the image editor 160.

Automation parameters 346 control how staffing manager 550 and assignment workflow manager 560 behave to staff the assignment. Invite selectors and shooter selectors along with their corresponding thresholds control staffing manager 550. Assignment workflow controls assignment workflow manager 560. Assignment workflow will be discussed in more detail below. The concept of a “selector” is central to the behavior of staffing manager 550. A selector is a software component that takes a set of photographers as input and creates as an output a subset of those photographers prioritized in a specific order. In certain embodiments, selectors may have the following characteristics. First, all selectors, regardless of implementation, may have the same base interface. For example, in the input would be a set of photographers and the output would be a subset of those photographers in prioritized order. Second, selectors may also be parameterized. These parameters control the behavior of the selector. The values of selector parameters have many possible sources, they may be: (1) set by assignment editor 140 manually; (2) derived from another source such as the staffing strategy or the photographer assignment invitations; or (3) calculated algorithmically by the selector itself. The next characteristic of a selector is that a selector may be chained together with other selectors to form more complex selectors. In this case the output of one selector is the input of the next selector. The final characteristic of a selector is that the implementation of the selector may be very simple, such as a single database query, or very complicated with many database queries and complex data analysis.

There are many possible implementations of a selector. The simplest form of a selector is a sorted database query against a set of photographers in the database. The result of this query is sorted by the database into some prioritized order. A more complex implementation of a selector might perform several queries using different expressions on the database to create several intermediate sets of photographers. A merging algorithm may then be applied to the several intermediate sets to create a single prioritized final set. These algorithms are written in software and may vary depending upon the goal of the selector.

The most common photographer data used by selectors includes: (1) equipment capability—the format and resolution of the equipment used by the photographer; (2) shooting locations—the locations where the photographer can shoot; (3) specialty—the categories of specialization that apply to the photographer; (4) ratings—any of the detailed ratings earned by the photographer; (5) current work load—the current assignment commitments each photographer has made; and (6) assignment invitation history—The number of assignments offered to the photographer and the time since their last offer.

Selectors are used by staffing manager 550 in two main forms. First, invite process 800 uses invite selectors to decide which photographers should be invited to an assignment. Second, assignment process 870 uses shooter selectors to decide which of the photographers requesting signup to a photo shoot should be assigned to that photo shoot. Both the invite selectors and the shooter selectors are lists of one or more selectors, in order. The current invite selector and current shooter selector define which selector is currently being used by staffing manager 550 for staffing. For each of the invite selectors and the shooter selectors there is also a threshold. The threshold is the goal, or target number, of photographers to be selected. The invite threshold defines the number of photographers invite process 800 is trying to obtain on the invite list. The shooter threshold is the number of photographers assignment process 870 is trying to obtain on the assigned list. Thresholds are set by assignment editor 140 during configuration of the automation parameters and may be changed by assignment workflow manager 560 during staffing.

In certain embodiments, assignments often have recurring characteristics that lead to reuse of one or more strategies for staffing. For example, some assignments may be designed to shoot a specific location, like the Empire State Building in New York. Because this is a location shoot, the highest probability for locating images is to first contact photographers that are located near the location to be shot. If this fails, the distance of the photographer from the location may be incrementally expanded until the desired number of photographers is obtained.

A staffing strategy is a pre-defined set of automation parameters that encapsulates the staffing behavior for a recurring assignment profile. A staffing strategy has two main sections, the automation parameter template and the strategy applicator. The automation parameter template is a template in the exact same structure as the automation parameters. It is basically a copy of a set of automation parameters with some data defined ahead of time and other data missing. In general, the automation parameter template contains three types of data. First, the automation parameter template may contain constant data, which is always the same regardless of the use of the strategy. For example, definition of the selectors to focus on location and incrementally expand the geographic range of the search is an example of constant data. Another type of data that may be contained in the automation parameter template is substitute data, which is data that is either copied directly from other data sources or computed by examining them. For example, the location of the photo shoot is a variable when using our example strategy. The location is defined in the photographer assignment invitation and can be automatically copied when the strategy is configured. The third type of data that may be contained in the automation parameter template is undefined data. Undefined data are the unknowns in the template that must be manually filled in by assignment editor 140 when configuring the automation parameters.

The strategy applicator is a software code component that is invoked by the system 100 when the staffing strategy is selected by assignment editor 140 for use in staffing a specific assignment. The strategy applicator has two main responsibilities. First, the strategy applicator is responsible for substitute data derivation, where the strategy applicator loads the photographer assignment invitation (and any other pertinent data) and uses this data to generate and fill in the substitute data with the applicable values for that assignment. The strategy applicator is also responsible for assignment editor interfacing, where the strategy applicator acts as a user interface component to prompt assignment editor 140 to define the undefined data. This user interface component can also be used by assignment editor 140 in the future to change the automation parameters.

The discussion above defined the concepts of invite selectors, shooting selectors, and the processes that use these to select and move photographer between the assignment staffing lists. In practice, it is possible to mix photographers from different (usually non-overlapping) groups or “populations.” For example, photographers with differing skill sets may be mixed based on the difficulty, importance, or value of an assignment. One way to do this is to select photographers based upon their ratings.

For example, consider classifications of photographers into three populations, a top tier population, a mid-tier population, and an unrated population. The top tier population contains photographers with a photographer rating that is greater than, or equal to, the minimum top tier rating. The mid-tier population contains photographers with a photographer rating greater than zero, but less than the minimum top tier rating. The unrated population contains photographers having a photographer rating of zero.

The shooter selection goal can be defined as a set of three numbers, being the number of desired shooters in each population tier. For example, an average photography assignment may have a shooter selection goal of one top tier photographer, three mid-tier photographers, and one unrated photographer. As another example, consider a photo shoot that is moderately difficult in regards to the required level of photographer skill. In this case, the shooter selection goal may include three top tier photographers, no mid-tier photographers, and two unrated photographers. As yet another example, consider a high priority photo shoot that is very difficult in regards to the required level of photographer skill. In this case, the shooter selection goal may include five top tier photographers, no mid-tier photographers, and no unrated photographers.

For the above example classifications, there are three populations being recruited in parallel—top tier, mid-tier, and unrated photographers. Staffing manager 550 is simplified and made more efficient if there are separate invite and shooter selector lists for each population. When using populations, processes 800, 840, and 870 require slight modifications from the steps described below with respect to FIGS. 9A-9C. For example, on assignment activation or on restart, invite process 800 runs once for each population in order. The invite selectors for population #1 (top tier photographers) are evaluated first until the invite threshold for population #1 is obtained or the population #1 selectors run out. Then, invite process 800 runs again for population #2 (mid-tier photographers). This same procedure repeats for population #3 (unrated photographers).

Other modifications to processes 800, 840, and 870 when using populations include that invite threshold escalations must specify the population it applies to, forcing selector evaluation for that population. An addition, when process 800 is evaluating whether or not an invite threshold is met for a specific population, it must only consider photographers that are members (i.e. were selected by selectors) of that particular population. Also, when a photographer requests to participate in a photo shoot, assignment process 870 runs for each current shooter selector in order of population #1, population #2, etc. In addition, when a shooter selection escalation occurs it must specify the population it applies to, forcing an evaluation of that population current shooter selector. Furthermore, when process 870 is evaluating whether or not a shooter threshold is met for a specific population, it must only consider photographers that are members (i.e. were selected by selectors) of that particular population.

Although, in certain embodiments, there are multiple populations, they are combined into a single set of assignment staffing lists. If a photographer happens to exist in multiple populations it does not matter. It simply means that the photographer has more than one chance of being selected by the selector for movement onto an assignment staffing list.

6. Assignment Workflow Manager

Business layer 500 also includes assignment workflow manager 560. A photography assignment may take several days to staff, shoot, review, and present to customer 102. Many factors can impede the effective fulfillment of an assignment order. Assignment workflow manager 560 manages assignments over their entire life cycle to ensure they are being effectively handled, and when automated assignment management is insufficient, assignment workflow manager 560 issues alarms to staff for manual intervention and problem resolution.

Customers 102 who place orders for assignments have an expectation of time in mind. Therefore, it is the timeliness of an assignment that serves as the core glue for all participating users (sales persons 130, assignment editors 140, photographers 152, and customers 102). Assignment workflow manager 560 is operable to act as a timeliness scrip ting engine. When an assignment is first submitted to assignment editor 140, assignment workflow manager 560 is notified. This creates a new workflow instance for that assignment. Then, when assignment editor 140 configures the automation parameters for that assignment, the workflow instance is configured as well. This newly configured workflow monitors the assignment from that point forward.

In general, a workflow is a template. A workflow instance is a persistent copy of the template for use in a single job. For example, but not by limitations, there may be a single initial workflow template for all assignments. When assignment workflow manager 560 receives notice that a sales order has been submitted for fulfillment, a new copy of this template is persisted in the database. This persistent copy is the workflow instance for the specific assignment and it monitors the assignment and if, in a set period of time, assignment editor 140 does not configure it for activation, it sends out alarms. In certain embodiments, the content of sales order 132 may dictate the form of the initial template. For example, an high-fee assignment may have a template that implements shorter alarm periods for assignment editor review to ensure that those assignments are completed on time.

When assignment editor 140 configures the automation parameters for the assignment, he or she selects a staffing strategy, which contains a much more detailed version of the assignment workflow. This workflow is associated with the already running workflow instance, and controls the assignment workflow from the point the assignment is activated onward. The workflow instance may be modified over time. For example, when an order is submitted, the workflow instance is initialized with an initial basic workflow. After staffing of the assignment has begun, the configured assignment workflow from the automation parameters is added to the existing workflow instance.

The basic design of a workflow instance is a list of event scripts. An event script consists of two parts. The first part is the event that triggers the action. When an event occurs the entire list of event scripts in the workflow instance is scanned. Any event script with a matching event is invoked. TABLE 1 illustrates an example set of events recognized by assignment workflow manager 560.

TABLE 1

| Input Event | Source | Description |
|---|---|---|
| Submit Order | Sales Interface 430 | Sales person submitted new assignment order for |
| | | processing by the Assignment Editor 140. |
| Staffing Has Begun | Staffing Manager 560 | Assignment Editor 140 has configured the |
| | | automation parameters and begun staffing. |
| Staffing Complete | Staffing Manager 560 | The Assignment List meets the Shooter Threshold. |
| Staffing Restart | Assignment Editor | Assignment Editor 140 has increased the Shooter |
| | Interface 440 | Threshold, requiring more staffing to occur. |
| Close | Assignment Editor | Assignment Editor 140 has closed the assignment. |
| | Interface 440 | |
| Timer Expired | Assignment Workflow | A timer for the assignment workflow has expired. |
| | Manager 560 | |

When an event matches against an event script in any active workflow instance, assignment workflow manager 560 invokes the script code for that event. This code can be implemented in any number of software languages, and may be pre-compiled or interpreted at run time. The script code can be very simple, or quite complex. Usually the script code is structured to test a condition first, such as to query the database and check the status of some portion of the assignment. A different action will occur based on the result of the test condition. TABLE 2 illustrates an example set of recurring actions that may be found in the script code for a workflow instance.

TABLE 2

| Action | Description |
|---|---|
| Invite Threshold Escalation | Increase the number of photographers for the Staffing Manager 550 |
| | to invite to the assignment. |
| Shooter Selection Escalation | Increase the number of photographers to assign to an assignment |
| | and/or change the selection criteria for the shooters. |
| Restart | Change the Automation Parameters for the assignment and issue a |
| | restart to the Staffing Manager 550. This is a way to change the |
| | Staffing Strategy mid stream if the existing strategy is ineffective. |
| Send Notification | Send a notification (like an email for example) to a user. This is |
| | used to send Alarms to staff members as well as for sending |
| | reminders and confirmations to Photographers. |
| Reschedule | Schedule the current Script Code to be re-run at a certain time in the |
| | future. This is used for recurring Script Code or for cases where a |
| | pre-condition has not yet been met. |
| Add New Event | Add one or more new Events to the workflow instance. New events |
| | may be copied directly from the originating workflow template or |
| | may be generated by the Script Code itself. |

As a way to illustrate the operation of assignment workflow manager 560, the following example is discussed. A corporate advertising department of a large beer company calls seeking a fresh new image with the following requirements as captured in a sales order 132: (1) stylish woman in bar drinking their beer; (2) cannot show hard liquor or tobacco in any form (static or being used); (3) must not show any brand of a competing company; (4) must clearly show their beer brand; (5) five days to deadline; (6) image resolution of 300 points per inch at 8×10 inches; and (7) setting must be in the United States.

Obviously there may be many additional details about the model, the angles, the lighting, etc. The above, however, is enough detail for the present example.

Sales person 130 receives authorization from customer 102 to start the shoot and submits an order 132 to assignment editor 140 on the sales interface 430. When this occurs, the default assignment workflow is used to create the initial workflow instance for the assignment. This workflow instance is designed to make sure assignment editor 140 edits and starts staffing the assignment promptly. TABLE 3 illustrates an example workflow instance for this example.

TABLE 3

| Event | Script Code (pseudocode) |
|---|---|
| Timer | If Assignment not Active send notification to Assignment |
| (30 min) | Editor 140 associated with the assignment notifying |
| | them of the existence of the new assignment. |
| | If Assignment active - do nothing; |
| Timer | If Assignment not active send notification to Assignment |
| (2 hours) | Editor 140 associated with the assignment and their boss |
| | informing them of the stagnant assignment. Reschedule same |
| | event in 2 hours. |
| | If Assignment active - do nothing. |

Assignment editor 140 now pulls up the sales order and copies it to create a photographer assignment invitation 142 using the assignment editing and staffing interface 440. Assignment editor 140 classifies the assignment as a Lifestyle shoot, and fills in a few additional details in the photographer assignment invitation that are critical to understanding the assignment from the photographer's point of view. Next, assignment editor 140 selects the appropriate staffing strategy for the assignment. This assignment is not a location shoot, and it is neither very short nor very long in duration. In addition, the difficulty of the assignment is moderate. Assignment editor 140 chooses a strategy which initializes the automation parameters to staff two populations (top tier and unrated) at a moderate rate (i.e., over 24 hours) with photographers having a specific specialty (in this case, Lifestyle) based on their ratings. Assignment editor 140 then configures the automation parameters.

For example, the automation parameters may be configured such that the top tier population (population #1) includes three photographers having a photographer rating in the upper 20% of the Lifestyle success rating, and a priority based on decreasing rating. Furthermore, population #1 may have a delayed shooter selection that includes the first six hours of the selection process are open to photographers rated in upper 10% of the Lifestyle success rating based on first-in first-out shooter selection priority. Shooter selection priority is described in more detail below. Thereafter, the assignment is open to photographers rated in the upper 20% of the Lifestyle success rating based on first-in first-out priority. Furthermore, the automation parameters may be configured such that the unrated population (population #2) includes two photographers with a rating of zero based on first-in first-out priority. In addition, the automation parameters may include escalation beginning at 12 hours after the assignment was created and escalating through volume incrementally up until 24 hours after the assignment was created followed by an alarm sent to assignment editor 140.

Once the automation parameters are configured, they activate the assignment. At this point, many new event scripts are added to the workflow instance, then a “staffing has begun” event is sent to assignment workflow manager 560 and staffing manager 550 is invoked.

The present example involves the use of tiered photographer ratings. Specifically, this example requires that three of the five photographers be in the upper 20% of ratings for Lifestyle success. As discussed above, there are many different ratings for each photographer. These ratings increase in proportion to the activity and performance of a photographer. Over time, the absolute value of ratings will progressively increase and spread out. To get a relative (i.e. percentage based) selection, the selector parameters for absolute rating values must be calculated by the selector by looking at the full range of current ratings in the system.

Although the present example uses only one photographer rating (in this case, Lifestyle success), there are two example variations on multiple rating selection, which may be used in certain embodiments. First, the “weighted rating aggregation” is a weighing of several different ratings in a selection to create a single aggregate rating. Assignment editor 140 (either directly or through Strategy selection) defines a set of ratings and a weighting of how each should be considered in the selection. The selector combines the ratings for a photographer based on the weighting and uses the aggregate result to tier the photographers into relative percentage based groups. This allows assignment editor 140 to give value not only to the success rating, but perhaps quality or reliability. Second, the “multiple rating selection” allows the specification of multiple ratings and a different percentage for each. This approach would not aggregate the ratings or weight them, but instead looks for matches in all rated categories (for example top 20% success and top 50% reliability). In the case of “multiple rating selection,” each of the multiple ratings is evaluated and the results are logically combined as an expression using normal logical operators such as and, or, and not.

In the present example, there are two populations being managed in parallel—specifically, a group of unrated photographers and a group of seasoned, proven photographers. This technique is used to manage delivery risk, while still allowing new photographers to prove themselves.

In general there are two approaches to shooter selection. To begin, “first-in first-out” priority matches the shooter selector to the invite selector. The first photographers to request to be assigned to a photo shoot get assigned until the shooter threshold is met. The second approach to shooter selection is called “delayed.” In delayed shooter selection, shooter selectors are picked by the workflow, and can be used to delay staffing decisions. In the present example, all upper 20% of the photographers are invited to request signup to the photo shoot, but for the first six hours the shooter selector will only allow the top 10% to be assigned. Then, after six hours, if the shooter threshold has not yet been met, assignment workflow manager 560 changes the shooter selector to allow all upper 20% photographers to be assigned. This technique can be used to delay selection for any kind of shooter distribution such as top rated, even rating spread, least assigned, closest, etc. Without the delay, however, the system could not compare alternative photographers and make a choice at shooter selection.

As discussed above, escalation techniques may be used to increase the number of qualified photographers considering the assignment. There are three ways to escalate the assignment. These techniques can be used alone or in combination with each other. The first escalation technique is a volume escalation technique where the thresholds for invitation and shooting are allowed to increase over time to obtain a large set of photographers with qualifications that match the requirements of the assignment. The second escalation technique is called generalization, which is a technique for increasing the pool of possible photographers by generalizing the selection criteria used by the selectors to invite or assign. This usually means the introduction of additional risk into the outcome, as the new matching photographers are either less proven or less experienced with respect to the assignment requirements. The third escalation technique is an incentive technique which increases the photographer pool by adding incentives to the assignment that motivate the already invited photographers to respond. In this case, assignment workflow manager 560 may send notifications to invited photographers with “spiffs” such as increased shooting fees, bonuses, and promotional awards.

Multiple techniques may be implemented to enable system 100 to help assignment editor 140 correctly configure the automation parameters prior to assignment activation. First, during configuration of the staffing strategy, system 100 can perform preliminary selection on the photographer pools to allow assignment editor 140 to see how large the populations are. This is essential for allowing assignment editor 140 to select the escalation strategy to use. Second, the ratio of the number of photographers being invited to join an assignment to the number of photographers requesting to participate in a photo shoot will vary based on the type of assignment and the population. Over time, system 100 can record the actual outcome of the assignment invitations based on selector type and parameters. This allows system 100 to, over time, estimate the outcome of a staffing strategy during configuration, further improving the ability of assignment editor 140 to tune the staffing strategy prior to activation.

TABLE 4 illustrates the two sets of selectors that are used in the example assignment discussed above.

TABLE 4

| | Population #1 - Top Tier | Population #2 - Unrated |
|---|---|---|
| Invite | Select: Shooting Location in US and | Select: Shooting Location in US and |
| Selector 1 | Specialty of Lifestyle and Megapixel | Specialty of Lifestyle and Megapixel |
| | Capability >7.2 and Lifestyle Success | Capability >7.2 and Overall Rating of 0 |
| | Rating in upper 20% of all Photographers | Prioritize: by decreasing time since last |
| | Prioritize: by decreasing Lifestyle | invitation |
| | Success Rating | Initial Invite Threshold: 50 |
| | Initial Invite Threshold: 60 | |
| Shooter | Select: Lifestyle Success Rating in upper | Select: all |
| Selector 1 | 10% of all Photographers | Prioritize: by order of photographer |
| | Prioritize: by order of photographer | response |
| | response | Initial Shooter Threshold: 2 |
| | Initial Shooter Threshold: 3 | |
| Shooter | Select: all | NONE |
| Selector 2 | Prioritize: by order of photographer | |
| | response | |

Using the selectors and thresholds shown in TABLE 4, staffing manager 550 can invite sixty Top Tier photographers and fifty unrated photographers to join an assignment. The first two unrated photographers to request to participate in the photo shoot are assigned. The first three top tier photographers in the upper 10% of LifeStyle success to request to participate in the photo shoot are also assigned. However, we need a workflow to help manage the assignment and take care of the cases when the initial pool of invited photographers does not meet the shooter threshold.

TABLE 5 illustrates a simplified example assignment workflow to handle the example assignment. Event scripts 1 and 9 in the workflow are added to the workflow instance for this assignment when assignment editor 140 configures the automation parameters and activates the assignment.

TABLE 5

| Event | | |
|---|---|---|
| Script ID | Event | Script Code (pseudocode) |
| 1 | Staffing Has Begun | Add Event Scripts 2-4 to the workflow instance. |
| 2 | Timer | If the Shooter Threshold has not been met for the |
| | (Staffing Has Begun + 6 | Top Tier Population, change the Top Tier Population |
| | hours) | Current Shooter Selector to Shooter Selector #2 by |
| | | issuing a Shooter Selection Escalation to the |
| | | Assignment Process. |
| 3 | Timer | For each population if the Shooter Threshold has not |
| | (Staffing Has Begun + 12 | been met, issue an Invite Threshold Escalation for |
| | hours) | that population to add 10 to the Invite Threshold. If |
| | | any Invite Threshold is issued as a result, Reschedule |
| | | this event for 1 hour in the future. |
| 4 | Timer | For each population if the Shooter Threshold has not |
| | (Staffing Has Begun + 24 | been met issue a notification (Alarm) to the |
| | hours) | Assignment Editor for manual intervention and |
| | | problem resolution. |
| 5 | Staffing Complete | Add Event Scripts 6-8 to the workflow instance, |
| | | remove Event Scripts 2-4 from the workflow |
| | | instance. |
| 6 | Timer | If there are staged images that have been waiting for |
| | (Staffing Complete + 24 | more than 4 hours that need to be reviewed, send a |
| | hours) | notification to the Photo Editor for this assignment |
| | | indicating photo review is overdue. Reschedule this |
| | | event for 6 hours in the future. |
| 7 | Timer | For each assigned photographer send an email |
| | (deadline − 24 hours) | notification asking them to report their status. |
| 8 | Timer | For each photographer who has not uploaded any |
| | (deadline − 12 hours) | images: |
| | | Send a notification to the photographer |
| | | prompting them to upload soon. |
| | | Send a warning notification to the |
| | | Assignment Editor indicating the |
| | | photographer has not yet uploaded |
| 9 | Close | Remove any remaining Event Scripts 1-9 from the |
| | | workflow instance. |

As shown in TABLE 5, event script 2 is responsible for the delayed shooter selection logic, giving preference to the upper 10% of photographers for the first six hours. Event script 3 is responsible for iterative volume escalation of ten new invitations per hour until staffing is complete. Event script 4 sends an alarm for manual staffing intervention. Event script 6 periodically looks for overdue photo editing and sends out alarms when it is located. Event script 7 is a standard status query e-mail to the photographers. Finally, event script 8 looks for upload failures by photographers 156 and sends an alarm for possible manual intervention.

The example assignment that is discussed above shows the basic interaction of system 100 elements. In certain embodiments, other operational features of system 100 may be present. For example, as images 158 are uploaded, there are many ways they can be automatically scanned using software to produce metrics on each image, such as, for example, resolution, color depth, and compression. In addition to watching for upload traffic, assignment workflow manager 550 could evaluate the quality of the uploaded images 158 as well, and promptly notify photographers 156 when upload images 158 fail to meet the criteria of the assignment. It is possible that such image pre-qualification can also be done by the photographer interface 405 prior to upload of the image, thus eliminating the resource overhead of transporting the large image data unnecessarily.

Furthermore, notification between system 100 and the photographers could be made two-way. This adds a new event to those recognized by assignment workflow manager 560 (this is referred to as “incoming communication”). Examples of mechanisms for facilitating the incoming communication may include an e-mail response to a notification e-mail sent by system 100 to the photographer with coded content that can be parsed by system 100, automated voice or touch-tone answering services, and client side software components used by photographers to send system 100 status communication. Two-way communication could be used for the tracking of photographer status and issues, allowing for more accurate automated escalation after staffing is complete.

7. Image Processing Manager

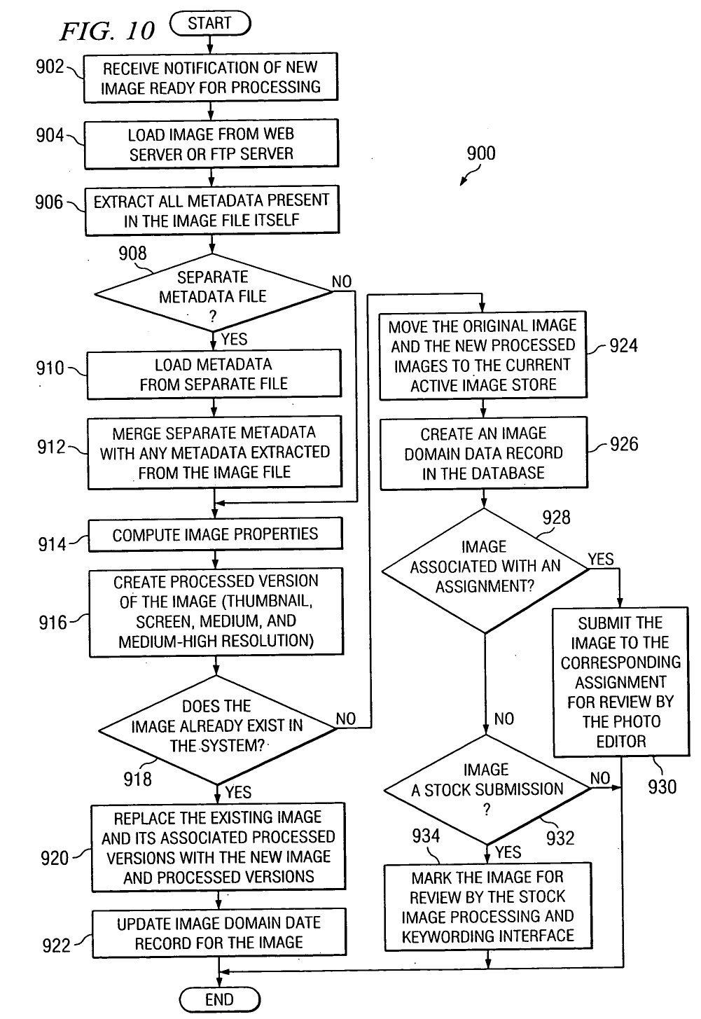

Manager layer 500 also includes an image processing (IP) manager 570 that is responsible for locating newly uploaded images 158, 163 or images that have been altered by internal users, such as image editor 160 or stock editor 170 and processing them into system 100. Whenever a new image 158, 163 is uploaded, IP manager 570 is notified of new image 158, 163 being ready for processing. For example, if image 158, 163 is uploaded using the HTTP protocol onto a local disk of a web server associated with system 100, such as server 110, the web server notifies IP manager 570 that image 570 is ready for processing. Alternatively, if image 158, 163 is uploaded using the FTP protocol to an FTP server associated with system 100, such as server 110, the FTP server notifies IP manager 570 that image 158, 163 is ready for processing. FIG. 10, discussed below, illustrates an example method for processing an uploaded image 158, 163. The type of image uploading possible using system 100 are described below with reference to image manager 580.

Image uploads to system 100 result in an image file along with metadata. Metadata is data, such as the photographer identity, assignment identity, captions, and keywords, that are associated with an image, such as uploaded images 158, 163, and which is provided either directly or indirectly by the photographer at the time of upload. Metadata may exist in two formats. First, most image file formats allow metadata to be inserted directly into the image file itself. Off-the-shelf image editing tools maybe used by photographers to insert their metadata directly into the image before uploading. An alternate method of metadata collection is for a web server associated with system 100, such as server 110, to prompt the photographer to enter the metadata at the time the image is uploaded. The metadata is sent to system 100 separately and is stored in a separate metadata file that accompanies image file 158, 163. During processing of a new image, image processing manager 570 uses both the image and the image metadata to determine how the image should be processed. Processing of an image generally involves moving the image to a secure storage location such as image library 175 to create an original image file 380, creating associated image domain data 350, and creating various processed versions of the image 390 such as low resolution images designed for display in lightboxes or other user interfaces.

IP manager 570 also controls image replacement. In some cases a user, such as image editor 160, stock editor 170, customer 102, or a photographer, may wish to modify an image, such as images 158, 163, 164, or 172, that is already present in system 100. To replace an image, the user may download a high-resolution version of the image, edit the image using commercially available image editing software, and then upload the modified image back into system 100. The upload of a modified image is processed by system 100 similarly to the upload of an image 158, 163, except that: (1) only computed image metadata, such as image resolution and depth, is modified; (2) the newly uploaded image and the resulting processed image replace the original image files in the appropriate locations in data layer 300; and (3) the image domain data record for the image is changed rather than created.

8. Image Manager

Image manager 580, in connection with the IP manager 570, manages all images in system 100. In certain embodiments, image manager 580 is capable of managing image uploading, image editing, image displaying, and image downloading. Image uploading may be accomplished by an image upload sub-manager 580a. Image upload sub-manager 580a performs four main functions. First, image upload sub-manager 580a controls photographer image uploading, where new images are uploaded to system 100 by a photographer as candidate images for either submission to an assignment or as submission for consideration as stock images not associated with an assignment. Photographers select the names of files on their local computer to upload and provide metadata, if not already present in the images. System 100 uploads each image 158, 163 and notifies IP manager 570 that each image 158, 163 is available for processing.

Second, the image upload sub-manager 580a also controls photographer release uploading, where a photographer may upload a scan or image of a release document associated with image 158, 163. There are two common types of release documents used by photographers, a model release and a property release. A model release is a paper document signed by a model granting the photographer rights to license and sell an image with the model in it. A property release is a paper document signed by a property owner giving a photographer the rights to license and sell photos that contain images of their property. Photographers either scan or take digital images of the signed releases associated with their submitted images (herein collectively called “release images”) and upload them to the image upload sub-manager 580a. When performing a photographer release upload, image 158, 163 is tagged by the photographer as a release image and the metadata contains the list of images 158, 163 to which the release document applies.

Third, image upload sub-manager 580a also facilitates image replacement and stock image submission. During image replacement, modified images are uploaded to replace an image on system 100 with a modified version of that image. An internal user, such as image editor 160 or stock editor 170, selects an existing image via one of the internal interfaces 420 for uploading. The internal user is prompted to browse for a specific file to upload, the user selects the file, the file is uploaded, and IP manager 570 is notified of the replacement image.

Fourth, image upload sub-manager 580a allows the batch upload of stock image submissions from internal users who may have received the stock images from alternate sources such as CD ROMs. An internal user of system 100, such as stock editor 170, uses stock image processing and key-wording interface 480 to select the batch images to be uploaded. The internal user then selects a batch of images from their local computer to upload as stock images. Images are uploaded and IP manager 570 is notified that each new stock image has been uploaded and is ready for processing. These newly uploaded images now appear in the work queue of the stock image processing and key-wording interface 480.

Image manager 580 also controls the image editing process. Image editing is the process of reviewing, sorting, and, if necessary, editing images 158, 163 that have been uploaded by photographers. The image editing function of image manager 580 serves image editing interface 450. In certain embodiments, the image editing function of image manager 580 is operable to perform various functions. For example, the image editing function may return a list of images associated with a specified lightbox (such as “staged,” “approved,” “rejected,” “parked,” and “releases,” discussed above) and photography assignment. In addition, the image editing function may move a specified set of images from one lightbox in a photography assignment to another lightbox in a photography assignment. Also, the image editing function may mark an image as either a candidate for a stock. Some images may be accidentally uploaded to system 100 by a photographer without properly being marked as release document scans (release document scans are obvious as they are images of signed paper documents). In this case, the image editor uses image editing interface 450 to move the release image into the “releases” lightbox, a lightbox designed to show all release images associated with the assignment.

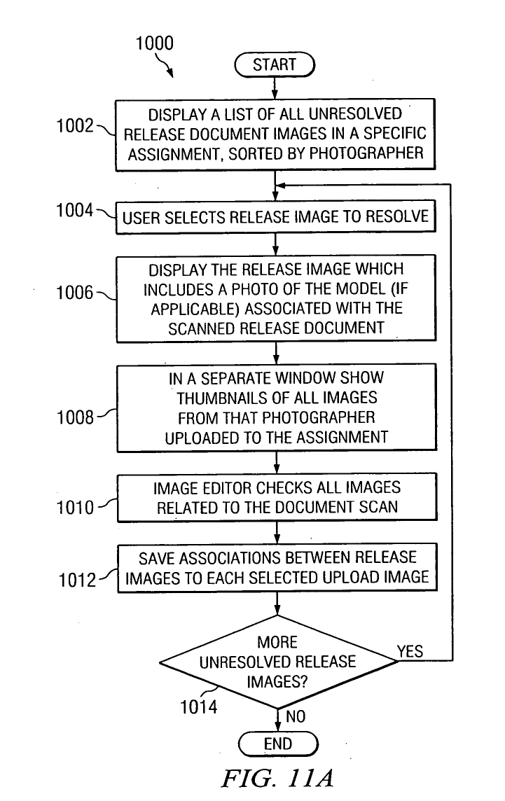

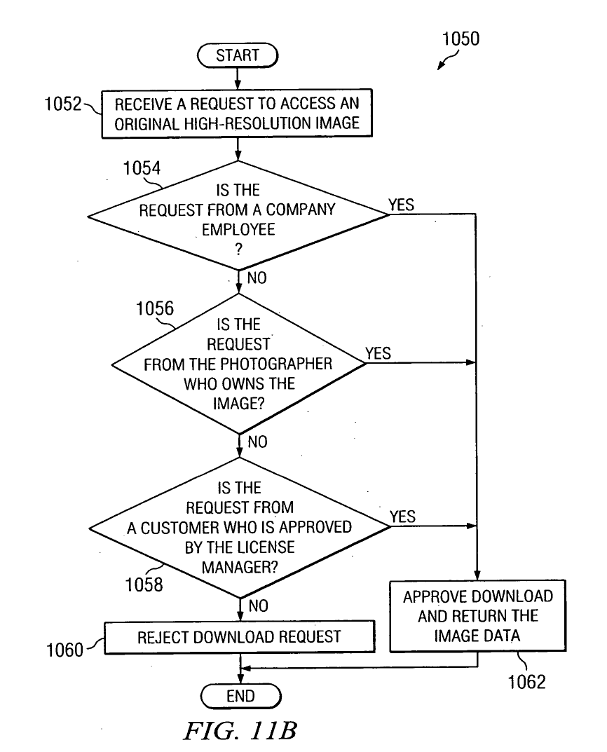

Furthermore, the image editing function associated with image manager 580 is responsible for associating release images with their corresponding images (when these scans have not already been associated with the appropriate images by the photographer during upload, herein called “unassociated” release images). FIG. 11A, discussed below, illustrates and example method for resolving these “unassociated” release images.

Image manager 580 also controls the display of images to internal and external users of system 100 using various external interfaces 402 and internal interfaces 420. In certain embodiments, a processed version 390 of an image is displayed, rather than the high-resolution original image 380. The display function of image manager 580 may also provide a list of and allow display of all release images associated with an image 158, 163.

Image manager 580 is also responsible for processing all requests to download the high-resolution original image 158, 163, including the approval or denial of access and the actual image transfer itself. FIG. 11B, discussed below, illustrates an example method for downloading images 158, 163.

9. Stock Manager

Business layer 500 also includes stock manager 590. Stock manager 590 provides the business functions required to import new images 164 into stock image library 180, search for images in stock image library 180, and submit images from stock image library 180 to an active photographic assignment. When an image 158 is reviewed by image editor 160, image 158 may be tagged as a selected image 164 to be used as a stock image. Alternatively stock images may be submitted by a photographer not associated with any active assignment, for example, by submitting images 163 as stock image submissions. Finally, stock images, such as images 163, 164, may be submitted by stock editor 170 in batch using stock image processing and key-wording interface 480. Images 163, 164 may be reviewed by stock editor 170, or other appropriate internal users of system 100, using stock image processing and key-wording interface 480. In certain embodiments, during this image review, stock editor 170 may edit annotation data in an image domain object, including marking image 163, 164 as a stock image, reviewing the caption, and reviewing or creating keywords (thus, creating key-worded image 172) for use in searching for the image in the future. This process allows a set of standard keywords to be used consistently across all images 172, increasing the probability of locating a desired image 172 during search. Furthermore, during image review, stock editor 170 may also edit image 163, 164 itself by downloading the original image 158, 163, editing the image using image editing software, and uploading the modified image to replace the existing image.

Stock manager 590 also facilitates the search for key-worded images 172. In certain embodiments, searching for images 172 is a simple database query. For example, the input to the query may include the required image characteristics, such as image resolution, as well as one or more keywords used to identify image 172. The query is executed on the image domain data in a database 350 and the search result is output as a list of possible matching images 172. The search results are communicated to stock image processing and key-wording interface 480 for use in presenting the results to a user. Stock manager 590 also serves the customer interface 415, allowing customer 102 to directly search for images prior to submission of a customer order.

Stock manager 590 also controls the submission of stock images 172 to a photography assignment. For example, if a search locates an existing image 172 that fulfills the requirements of a new photography assignment, that image 172 may be reused for the new assignment, thereby eliminating the need to have a group of photographers conduct a new “photo shoot” associated with the new assignment. To submit stock images in fulfillment of a photography assignment, stock manager 590 uses license manager 600, discussed below, returns a list of active existing licenses for stock image 172. The terms of the license are displayed to an internal user, such as assignment editor 140. If the desired terms of use of image 172 associated with the new assignment do not conflict with any outstanding licenses on image 172, image 172 is submitted to the assignment as if it were an image that had been uploaded by a photographer and approved by image editor 160.

10. License Manager

Business layer 500 also includes license manager 600, which is responsible for the management of all image licenses in system 100. In certain embodiments, license manager 600 may be queried to return all active licenses associated with an image in system 100. License manager 600 loads the image domain data for an image and scans the licenses. Any license whose term is still in effect is returned during the search. This functionality is predominantly used to review licenses on images 172 prior to submitting them to fulfill new photography assignments.

License manager 600 may also control the creation of new image licenses. Sales interface 430 is used to license images for customer 102. When customer 102 selects an image they desire, customer 102 may contact a salesperson 130 to purchase a license to use that image. The terms of a customer's intended use are input when a customer order 114 or sales order 134 is created, as discussed above. License manager 600 is used to create a new license in the image domain data 350 for the particular image that is licensed.

License manager 600 may also check image data 350 for the existence of valid licenses for a given image. For example, license manager 600 can evaluate if a customer 102 has the right to access an image. To evaluate a valid license, license manager 600 loads image domain data for the requested image and searches the licenses associated with the requesting customer 102. If a license is located whose term is still in effect, license manager 600 approves the customer's access to the image. Alternatively, if the license term is not in effect or a license does not exist for that image, license manager 600 rejects a customer's access to the image.

Example Project and Assignment Data

FIG. 4A is a block diagram illustrating an example of project and assignment data 340. In certain embodiments, data 340 includes projects 341 and assignments 342. Assignments 342 are orders for the provision of an image to a customer 102. Assignments may occur in related groups, known as projects 341. Project 341 is similar to a folder that contains one or more assignments 342, such as assignments 342a-342c in the illustrated example. In certain embodiments, assignment 342 may be composed of six basic data groups: customer order 114, sales order 132, assignment invitation 142, automation parameters 346, assignment staffing lists 347, and lightboxes 348.

As discussed above, customer order 114 contains the definition of assignment 342 as entered by customer 102 when customer 102 submits an image order through network 120. In certain embodiments, customer 102 uses customer interface 415 when placing a customer order 114. Customer order 114 may or may not be present in data 340. For example, if customer 102 places an image order via a telephone call to salesperson 130, a sales order 132 is generated without a corresponding customer order 114. Sales order 132 includes definition of assignment 342 as entered or modified by salesperson 130 using sales interface 430. In certain embodiments, sales order 132 may be created from scratch or by copying and modifying an existing customer order 114.

Each assignment 342 may also contain an assignment invitation 142. Assignment invitation 142 is the message sent to photographer network 152 to invite photographers to shoot the assignment. Assignment invitation 142 contains the definition of the respective assignment 342, including, but not limited to, the subject of the image, the desired image size, and/or the desired image resolution, as modified by assignment editor 140 using assignment editing and staffing interface 440. In certain embodiments, assignment invitation 142 may be created by copying and modifying sales order 132.

Each assignment 342 may also contain automation parameters 346 which may contain a set of properties defined by assignment editor 140 used to control the automated staffing and workflow execution of assignment 342. Each assignment 342 may also contain assignment staffing lists 347 which contains a short list 347a of photographers that have been considered for a photo shoot, an invited list 347b of photographers that have received or will be sent assignment invitation 142, and an assigned list 347c containing information related to assigned photographers 156. In certain embodiments, each assignment 342 may also contain lightboxes 348. Lightboxes 348 contains “lightboxes” that are sets of pointers 349 to images stored in system 100 associated with each assignment 342. For example, but not by way of limitation, pointers 349 may include pointers to rejected images or approved images 162.

Example Image Domain Data

FIG. 4B is a block diagram illustrating example domain data for an image 370. In certain embodiments, each image 370 may contain four data groups. For example, each image 370 may contain a basic properties data group 372, an annotations data group 374, one or more licenses 376, and a storage location data group 378. Basic properties data group 372 may contain a collection of the basic image properties, such as its resolution, color space, original format, and information associated with the photographer who took the image. An image's basic properties may be obtained at the time the image is uploaded to the system by the photographer by extracting them from the image itself. Annotations data group 374 contains properties associated with the image, such as titles, captions, whether or not the image is considered part of stock library 180, and search keywords. Annotations may be created either by the photographer, image editor 160, stock editor 170, or any other individual with editorial access to the images in system 100.

In certain embodiments, each image 370 may be associated with one or more licenses 376. License 376 defines the sale of rights to customers 102 for use of an image. License 376 may include license terms, such as license duration and license scope, and the license price. System 100 manages and distributes licenses 376 such that no two licenses 376 may have conflicting license terms. In addition, each image 370 may be associated with storage location data group 378. Storage location data group 378 may contain a set of pointers 379 to the actual image files, which may be stored outside the domain database as flat files. In addition to the location of the original uploaded image 380, storage location data group 378 may also identify a series of processed images 390 used for presentation or use of an image by different audiences.

Example Graphical User Interface

FIGS. 5A-5K illustrate example graphical user interfaces associated with system 100, as described above with reference to interface layer 400. FIG. 5A illustrates an example photographer profile sub-interface 405b. FIG. 5B illustrates an example view of assignment sub-interface 405c presenting to a photographer their assignment invitations 142. FIG. 5C illustrates an example view of assignment sub-interface 405c presenting to a photographer the detail of a specific assignment with options to either request signup or decline to shoot the assignment. FIG. 5D illustrates an example view of assignment sub-interface 405c presenting to a photographer of their active assignments. FIG. 5E illustrates an example view of images sub-interface 405d during uploading of an image 158.

FIG. 5F illustrates an example of the lightbox portion of image sub-interface 415c, which allows customer 102 to see the set of approved images 162 for a particular assignment. FIG. 5G illustrates an example view of sales order sub-interface 430b. FIG. 5H illustrates an example of sub-interface 440c used by assignment editor 140 to search for photographers based on the information in their profiles and the requirements of the assignment. FIG. 5I illustrates an example of sub-interface 440c used by assignment editor 140 to view the list of photographers on the invited list 347b and to move a photographer or group of photographers to the assigned list 347c for a given assignment. FIG. 5J illustrates an example of sub-interface 440c used by assignment editor 140 to view which of the invited photographers have requested signup to an assignment and to create the assigned list of photographers 347c. FIG. 5K illustrates an example view of image staging sub-interface 450b, which displays uploaded images 158 to image editor 160 for approval or rejection.

Example Methods for Adding Photographer to Photographer Network

FIG. 6A illustrates an example method 500 for adding a photographer to photographer network 152 of system 100. The method begins at step 502 where an internal user of system 100, such as an assignment editor 140, invites a photographer to join photographer network 152 and creates a photographer login with minimal photographer profile information. At step 504, the internal user of system 100 sends marketing materials or e-mails to a photographer inviting the photographer to join photographer network 152 and providing the photographer with a login to enable them to access system 100. At step 506, the invited photographer uses the provided login information to login into system 100, such as through photographer interface 405. At step 508, the photographer is presented with a “contributors agreement” through sub-interface 405a which specifies the terms and conditions that the photographer must agree to before becoming a member of photographer network 152. At step 510, the photographer is given the choice to either accept or decline the contributors agreement. If the photographer declines to accept the agreement, the method continues to step 512 where the photographer's login session is ended.

Alternatively, if the photographer accepts the contributors agreement, the method continues to step 514 where the photographer updates his account information and user profile with the information required to match the photographer with a photography assignment. At step 516, the photographer logs off of system 100. At step 518, an internal user, such as assignment editor 140, reviews a list of pending photographers using sub-interface 460c, which includes each photographers profile information. At step 520, a determination is made whether or not to activate a given photographer. If the photographer is not activated, the method proceeds to step 522 where an e-mail is sent to the photographer describing why they were not accepted into photographer network 152 and method 500 ends. Alternatively, if a determination is made to activate the photographer, the method proceeds to step 524 where the photographer is activated and is considered by staffing manager 550 for future photography assignments. At step 526, an e-mail is sent to the photographer informing him that he has been accepted into photographer network 152.

FIG. 6B illustrates another example method 550 for adding a photographer to photographer network 152 of system 100. The method begins at step 552 where a photographer visits a web site associated with system 100 and completes a form requesting participation in photographer network 152, including all of the photographer's profile data. At step 554, the photographer is presented with a “contributors agreement,” which specifies the terms and conditions that the photographer must agree to before becoming a member of photographer network 152. At step 556, the photographer is given the choice to either accept or decline the contributors agreement. If the photographer declines to accept the agreement, the method continues to step 558 where the photographer's login session is ended.

Alternatively, if the photographer accepts the contributors agreement, the method continues to step 556 where the photographer logs off of system 100. At step 562, an internal user, such as assignment editor 140, reviews a list of pending photographers, which includes each photographers profile information. At step 564, a determination is made whether or not to activate a given photographer. If the photographer is not activated, the method proceeds to step 566 where an e-mail is sent to the photographer describing why they were not accepted into photographer network 152 and method 550 ends. Alternatively, if a determination is made to activate the photographer, the method proceeds to step 568 where the photographer is activated and is considered by staffing manager 550 for future photography assignments. At step 570, an e-mail is sent to the photographer informing him that he has been accepted into photographer network 152.

Although example methods are illustrated, the present invention contemplates two or more steps taking place substantially simultaneously or in a different order. In addition, the present invention contemplates using methods with additional steps, fewer steps, or different steps, so long as the steps remain appropriate for adding a photographer to photographer network 152. Furthermore, methods 500, 550 may be modified when system 100 is used to provide custom artistic content other than, or in addition to, images, such as video, audio, and text content, as discussed above.

Example Photographer Rating Methodology

FIG. 7 illustrates an example photographer rating “tree” 600 implemented by photographer manager 510 to rate photographers in photographer network 152. As discussed above, system 100 may be implemented to provide other forms of artistic content in addition to images. Although the discussion of ratings that follows focuses on photographer ratings, a similar rating scheme may be implemented for other artistic content providers, such as musicians, authors, film makers, etc.

All photographers have a single top-level general rating 602. The number and types of ratings in the lower levels can change. Photographer manager 510 implements two classes of ratings. The first rating class is referred to as a “common rating.” The common rating always applies to a photographer, regardless of the assignment. For example, reliability 610 and communication and attitude 620 are examples of common ratings. Some common ratings may also apply outside the context of assignments, such as, for example, the photographer may achieve a high rating if he promotes the use of system 100 to potential customers 100. In the present example, each common rating 610, 620 comprises twenty five percent of the photographer's general rating 602.

The second rating class is referred to as a “conditional rating.” Conditional ratings may or may not apply depending upon the assignment itself. For example, in FIG. 7, conditional ratings may be based on the photographer's area of specialization 630, such as architecture 630a, lifestyle 630b, or landscape 630c. Although specific specialization areas 630 are described above, other specialization areas 630 may include, but are not limited to, travel, sports, digital art/digital manipulation, people, products, documentary/photojournalism, landscape, wildlife, still life, studio, fashion, glamour, architecture, portraiture, action, aerial, animals, automotive, black and white, business, children, collage/montage, conceptual, event/publicity, food/beverage, hospitality, interiors, lifestyle, location, medical, military, motion, panoramic, scientific, transportation, and underwater.

In certain embodiments, where system 100 is used to provide other forms of artistic content as described above, areas of specialization may include, for example, classical or jazz (for musicians), fictions or literature (for writers), or commercials or documentaries (for film makers). In the present example, the remaining fifty percent of general rating 602 is divided evenly among the number of specialized areas 630 that are defined for the assignment.

When a assignment invitation 142 is created by assignment editor 140, assignment editor 140 classifies the assignment based on specialized areas 630. Assignment editor 140 may pick one or more specialized areas. For example, a landscape (landscape specialty 630c) with people in the image (lifestyle specialty 630b) would comprise two specialties. All ratings associated with the specialties defined in the assignment invitation apply to the photographer involved in the assignment. In certain embodiments, ratings 635 may be included under each area of specialty 630.

TABLES 6-7, discussed below, illustrate example rating events and calculations for a photographer within system 100. A rating event is an event that occurs in system 100 that will change one or more photographer's ratings. In certain embodiments, rating events occur automatically. Alternatively, rating events may be manually input into system 100 by an internal user, such as assignment editor 140. For example, a positive rating event is an event where a photographer has performed in accordance with the rating type and results in a positive increase in the photographer's rating. A negative rating event is an event where a photographer fails to perform in accordance with the expected rating type and results in a decease in the photographer's rating.

In certain embodiments, all rating events are defined in terms of the lowest level rating (the lowest level of the tree). The lowest level ratings may be persistent values associated with a photographer. All parent (or higher level) ratings may be calculated by combining lower level ratings using a set of percentage-based weighting factors. Thus, when a rating is changed, all parent (higher level) ratings change as well. In other words, lower level ratings are specializations of higher level ratings, representing more detail, rather than alternative specializations. Alternative ratings are created by adding more ratings at the same rating level (of the tree).

TABLE 6 illustrates an example rating table comprising ratings events, the occurrences of rating events, and sources that lead to the occurrence of a rating event for common ratings such as “reliability,” “communications and attitude,” “quality,” and “success.”

TABLE 6

| | | |
|---|---|---|
| Rating Event | Occurrence | Source |

Reliability

| | | |
|---|---|---|
| Photographer reviews and requests | Per | Positive - Photographer hits Request or Decline |
| or declines assignment | Assignment | for an assignment |
| | | Negative - Photographer does not hit Request or |
| | | Decline for an assignment |
| Photographer submits images | Per | Positive - Photographer uploads image to |
| when assigned | Assignment | assignment |
| | | Negative - Photographer does not upload image |
| | | to assignment |
| Photographer re-shoots or edits | Per | Manual event from Assignment Editor |
| images when asked | Assignment | |

Communications and Attitude

| | | |
|---|---|---|
| Photographer communicates | Anytime | Manual event from Assignment Editor 140 |
| when they need help | | |
| Photographer communicates | Anytime | Manual event from Assignment Editor 140 |
| proactively when they need help | | |
| Photographer is responsive to | Anytime | Manual event from Assignment Editor 140 |
| inquiries | | |
| Photographer has positive attitude | Anytime | Manual event from any Internal User |
| Photographer promotes the | Anytime | Manual event from any Internal User |
| company | | |

Quality

| | | |
|---|---|---|
| Photographer uses lighting and | Per Image | Manual from Image Editor |
| exposure | | |
| Photographer uses image scanning/ | Per Image | Manual from Image Editor |
| editing appropriately | | |
| Photographer has good image | Per Image | Manual from Image Editor |
| composition | | |
| Photographer is creative | Per Image | Manual from Image Editor |
| Photographer submits release | Per Image | Manual from Image Editor |
| forms as required for images | | |

Success

| | | |
|---|---|---|
| Image submitted and accepted for | Per Image | Positive - Image is moved to Approved |
| customer review | | Lightbox |
| | | Negative - Image is moved to the Rejected |
| | | Lightbox |
| Image submitted and tagged for | Per Image | Positive - Photo Editor tags image for stock |
| use as stock | | Negative - no negative event |
| Image submitted and licensed | Per Image | Positive - Sales licenses image |
| | | Negative - no negative event |
| Extraordinary Image | Per Image | Positive - Photo Editor tags image as |
| | | extraordinary |
| | | Negative - no negative event |

As illustrated in TABLE 6, a photographer may take various actions which affect his or her rating. For example, a photographer may receive a “positive” reliability rating for submitting a photo for an assignment on time. As another example, a photographer may receive a “negative” success rating if his or her submitted image is rejected. Although TABLE 6 includes example rating events, occurrences, and sources, any other appropriate rating events, occurrences, and sources may be used to generate photographer ratings in accordance with the present invention.

TABLE 7 illustrates an example calculation which shows how ratings may change in response to a positive rating event of 1 to rating 635b.

TABLE 7

| Rating | Change |
|---|---|
| Still Life/Success/Images submitted | 1 |
| and accepted for customer review 635b | |
| Still Life/Success 635a | 1 × 15% = 0.15 |
| Still Life 630a | 0.15 × 75% = 0.1125 |
| General 602 | 0.1125 × 50% = 0.05625 |

For example, if a photographer is assigned to photograph a still life image and he submits an image 158, that is accepted for review by customer 102, there would be a positive rating event for each of the conditional ratings “still life” 630a, “success” 635a, and “images submitted are accepted for customer review” 635b, plus the common general rating 602. Although the change to general rating 602 is small, the cumulative effect of this rating change as applied when each image 158, 163 is submitted can have a substantial effect on a photographer's general rating 602.

In addition, other events can improve a photographer's general rating 602, such as when an image is selected for stock image library 180 or if an accepted image 162 or key-worded image 172 is selected by a customer 102 for licensing. Also, each image 158 is rated for quality, resulting in additional ratings changes. When the assignment is completed, the photographer's overall reliability 610 and communication 620 may be rated, resulting in further increases or decreases in general rating 602. Consequently, using a tree rating structure, such as tree 600 of FIG. 7, for rating events and incremental rating calculations, such as those illustrated calculations in TABLE 7, allows photographer manager 510 to develop and increasingly accurate profile on the behavior of a photographer to allow staffing strategies to work effectively.

An aggregate rating is defined as a rating calculated by combination of equivalent ratings that appear in the same location of the rating tree relative to a common root node. For example an overall aggregate “success” rating can be created by adding the “success” rating of every specialty shown in example rating tree FIG. 7. This rating is a general measure of photographer success across all specialties, compared to the above example of a “still life success” rating which is more specific.

Examples of Creating and Changing Assignments

FIG. 8A illustrates an example method 700 for creating a new photographic assignment using project/assignment manager 540 of system 100. The method begins at step 702 where a customer 102 defines a specific usage for the desired image using assignment sub-interface 415b. At step 704, project/assignment manager 540 prices the desired image based on the usage requirements of customer 102. At step 706, customer 102 defines the desired image, such as by inputting a written description or attachments through assignment sub-interface 415b. At step 708, customer 102 submits the image request in the form of customer order 114. At step 710, salesperson 130 reviews the image request. At step 712, a determination is made as to whether or not more information is required to complete the image request. If further information is required, customer 102 is contacted, such as via telephone call from salesperson 130, and asked to provide the need information. Alternatively, if no further image request information is required, at step 716, a sales order 134 is created by copying customer order 114.

At step 718, an internal user of system 100, such as salesperson 130, may add any additional information or make corrections or adjustments to sales order 130 using sales order sub-interface 430b. At step 720, sales order 134 is submitted to assignment editor 140. At step 722, assignment editor 140 reviews sales order 134. At step 724, a determination is made as to whether or not more information is required to execute sales order 134. If more information is required, assignment editor 140 may contact salesperson 130 to coordinate the exchange of the additional required information. Alternatively, if no further information is required by assignment editor 140, at step 728, sales order 134 is copied to create a assignment invitation 142. At step 730 assignment editor 140 may modify the assignment invitation using assignment editing sub-interface 440b to ensure that it contains sufficient information to enable the photographer to execute the associated photography assignment.

Although example methods are illustrated, the present invention contemplates two or more steps taking place substantially simultaneously or in a different order. In addition, the present invention contemplates using methods with additional steps, fewer steps, or different steps, so long as the steps remain appropriate for creating a new photographic assignment.

FIG. 8B illustrates an example method 750 for changing a photographic assignment using project/assignment manager 540 of system 100. The method begins at step 752 where a request to change a photography assignment is generated, such as by customer 102 or salesperson 130. At step 754, assignment editor 140 reviews the change request. At step 756, a determination is made as to whether or not further clarification is required regarding the assignment change request. If further clarification is required, at step 758, assignment editor 140 may discuss the change request with the person who generated it, such as customer 102 or salesperson 130. In the alternative, if no further clarification of the change request is required, at step 760 a determination is made as to whether or not the delivery date of the image must change due to the assignment change request. If a delivery date change is required, at step 762, the person who generated the change request is asked to approve the new delivery date. If no change in the delivery date is required or if the person who generated the change request approves the new delivery date, at step 764, assignment editor 140 edits a assignment invitation.

At step 766, a determination is made as to whether or not a material change is required to the assignment invitation based on the assignment change request. If a material change to the assignment invitation is required, a notification is sent to the invited photographers and the assigned photographers 156 communicating the change to the assignment. If no material change is made to the assignment invitation or if the invited and assigned photographers have been notified of a material change to the assignment invitation, at step 770 the assignment change in completed and method 750 ends.

Although example methods are illustrated, the present invention contemplates two or more steps taking place substantially simultaneously or in a different order. In addition, the present invention contemplates using methods with additional steps, fewer steps, or different steps, so long as the steps remain appropriate for changing a photographic assignment.

Examples of Invite, Review, and Assignment Processes

FIG. 9A illustrates an example invite process 800 of staffing manager 550. Invite process 800 may begin in three different instances. First invite process 800 may begin at step 802 where assignment editor 140 activates the assignment after configuring the automation parameters. Alternatively, invite process 800 may begin at step 802 when either the assignment editor 140 or the assignment workflow manager 560 change the automation parameters for the assignment. This may happen as a result of an alarm or a new strategy escalation. The third instance in which invite process 800 may be started occurs when assignment workflow manager 560 requests an increase in the invite threshold.

After invite process 800 is started at step 802, it continues to step 804 where the current invite selector is evaluated against the set of all active photographers in photography network 152 to create a prioritized list of resulting photographers. At step 806, any photographer in the result from step 804 that is already on any of the assignment staffing list for the current assignment is removed from the selector result. At step 808, the resulting photographers are added to a short list. At step 810, the photographers are moved from the short list to the invite list in order of selector priority until either the short list is empty or the invite threshold is met. Concurrently, invite process 800 continues from step 810 to steps 812 and 820. At step 820, an e-mail invitation is sent to each photographer who was moved from the short list to the invite list in step 810. From step 820, process 800 continues to step 822 where each photographer undergoes a review process as discussed below.

From step 810, process 800 also continues to step 812 where a decision is made as to whether or not the invite threshold is met. If the invite threshold is met, invite process terminates at step 816 because the number of photographers on the invite list equals the number of photographers specified by the current invite threshold. If, the invite threshold is not met, process 800 continues to step 814, where a determination is made as to whether or not another selector is available in the automation parameters. If no more selectors are available in the automation parameters, process 800 terminates at step 816. If, on the other hand, another selector is available in the automation parameters, process 800 continues to step 818 where the current invite selector is changed to the next invite selector in the automation parameters. Process 800 then loops back to step 804 and proceeds as described above using the new invite selector.

As discussed above, when using populations, invite process 800 requires slight modification from the steps described above. For example, on assignment activation or on restart, invite process 800 runs once for each population in order. The invite selectors for population #1 (top tier photographers) are evaluated first until the invite threshold for population #1 is obtained or the population #1 selectors run out. Then, invite process 800 runs again for population #2 (mid-tier photographers). This same procedure repeats for population #3 (unrated photographers). Another modification to processes 800 when using populations includes that invite threshold escalations must specify the population it applies to, forcing selector evaluation for that population. Also, when process 800 is evaluating whether or not an invite threshold is met for a specific population, it must only consider photographers that are members (i.e. were selected by selectors) of that particular population.

Although example methods are illustrated, the present invention contemplates two or more steps taking place substantially simultaneously or in a different order. In addition, the present invention contemplates using methods with additional steps, fewer steps, or different steps, so long as the steps remain appropriate for implementing invitation process 800.

FIG. 9B illustrates an example review process 840 of staffing manager 550. Review process 840 begins at step 842 a new photographer is moved to the invite list by the invite process. At step 844, the new photographer receives an assignment invitation 142 to participate in the photo shoot via e-mail. At step 846, the new photographer logs in to system 100 via photographer interface 405 to view the assignments the photographer has been invited to participate in. At step 848, system 100 presents a list of all assignments the photographer has been invited to participate in. In certain embodiments, this list may exclude any assignment where the shooter threshold is equal to the number of photographers on the assigned list (i.e. the assignment is full). At step 850, the photographer reviews the assignment invitation 142 contained within the assignment invitation 142.

From step 850, review process 840 may proceed to step 852, where the photographer must make a decision as to whether or not he or she wants to participate in the assignment. If the photographer does not wish to participate in the assignment, the photographer may select, at step 854, a “DECLINE” button associated with photographer interface 405 and review process 840 ends. However, if the requests signup to an assignment, the photographer may select, at step 856, a “REQUEST” button associated with photographer interface 405 and review process 840 proceeds to step 858.

At step 858, a decision is made as to whether or not the assignment became full while the photographer was viewing the assignment invitation. If the assignment did not fill up while the photographer was viewing the assignment invitation, review process 840 proceeds to assignment process 870, discussed in more detail with respect to FIG. 9C. However, if the assignment did fill up while the photographer was viewing the assignment invitation, review process 840 proceeds to step 860 where the photographer is notified that the assignment filled-up while the photographer was considering whether or not to request the assignment and process 840 terminates.

Although example methods are illustrated, the present invention contemplates two or more steps taking place substantially simultaneously or in a different order. In addition, the present invention contemplates using methods with additional steps, fewer steps, or different steps, so long as the steps remain appropriate for implementing review process 840.

FIG. 9C illustrates an example assignment process 870 of staffing manager 550. Assignment process 870 may begin in two different ways. First, assignment process 870 may begin when a photographer on the invited list chooses to request signup to the photo shoot, as discussed above with regard to FIG. 8B. Alternatively, assignment process 870 may begin when assignment workflow manager 560 initiates a shooter selection escalation.

After assignment process 870 begins, in one of the two ways described above, assignment process 870 proceeds to step 872 where the list of the photographers on the current invite list who have requested signup to the assignment and the set of photographers already on the assigned list are added together to create a comparison photographer set.

At step 874, the current shooter selector is evaluated against the comparison photographer set resulting in a prioritized list photographers. At step 876, a decision is made as to whether or not any photographer in the result of step 874 is on the invite list. If there are no photographers that are both on the invite list and in the result of the selector evaluation in step 874, assignment process 870 terminates at step 888. However, if there are photographers that are both on the invite list and in the result of the selector evaluation in step 874, assignment process 870 proceeds to step 878 where the photographers that have requested to participate in the assignment are moved from the invite list to the assigned list in order of selector priority. In certain embodiments, the photographers that have requested to participate in an assignment are moved from the invite list to the assigned list in order of selector priority until either: (1) there are no more photographers that have requested to participate in a photo shoot selected by the current shooter selector; or (2) the shooter threshold is met.

Assignment process the proceeds to step 880 where an e-mail is sent to each photographer that was moved from the invite list to the assigned list notifying them that they have been assigned and are to begin the photo shoot. At step 882, a decision is made as to whether or not the number of photographers on the assigned list is equal to the shooter threshold. If the shooter threshold is not met, assignment process 870 terminates at step 888. However, if the shooter threshold is met, assignment process 870 proceeds to step 884 where an e-mail is sent to each photographer who requested signup to the assignment but was not assigned thanking them for their interest. Assignment process 870 then proceeds to step 886 where assignment workflow manager 560 is notified that staffing is complete.

Although invite process 800 and assignment process 870 are similar, they have an important difference. For example, invite process 800 will automatically change invite selectors to select more photographers until the invite threshold is met. Assignment process 870, however, will only evaluate the current shooter selector. Assignment workflow manager 560 must change the shooter selector. Invite process 800 is designed to get the assignment invitation in front of all qualified photographers (up to the invite threshold) as soon as possible, so they may have the most time available to review and decide if they are to shoot the assignment. Assignment process 870, however, is designed to obtain the best, most optimal, shooting group. Because review process 840 requires human photographers to complete the process, it has a variation in response time from one photographer to another (unlike a search in invite process 800). Therefore, assignment process 870 waits, allowing the photographers a reasonable amount of time to review the assignment, before changing the selection criteria.

As mentioned above, when using populations, assignment process 870 may require slight modifications from the steps described above. For example, when a photographer requests to participate in a photo shoot, assignment process 870 runs for each current shooter selector in order of population #1, population #2, etc. In addition, when a shooter selection escalation occurs it must specify the population it applies to, forcing an evaluation of that population current shooter selector. Also, when process 870 is evaluating whether or not a shooter threshold is met for a specific population, it must only consider photographers that are members (i.e. were selected by selectors) of that particular population.

Although example methods are illustrated, the present invention contemplates two or more steps taking place substantially simultaneously or in a different order. In addition, the present invention contemplates using methods with additional steps, fewer steps, or different steps, so long as the steps remain appropriate for implementing assignment process 870.

Example of Processing Uploaded Images

FIG. 10 illustrates an example method 900 for processing an uploaded image 158, 163 using IP manager 570. The method begins at step 902 where a notification is received that a new image 158, 163 is ready for processing. At step 904, image 158, 163 is loaded from server 110 of system 100, such as a web server or an FTP server. At step 906, all metadata present in the image file is extracted. At step 908, a determination is made as to whether or not a separate metadata file exists for image 158, 163. If a separate metadata file exits for image 158, 163, the method proceeds to step 910 where the metadata is loaded from the separate file. The method then proceeds to step 912 where the separate metadata is merged with the metadata that was extracted from the file containing image 158, 163. After completion of step 912, or a determination is made a step 908 that no separate metadata file exists for image 158, 163, the method proceeds to step 914 where image properties, such as resolution and depth, are computed from analysis of image 158, 163 itself.

At step 916, processed versions of image 158, 163 are created, such as a thumbnail image or a series of images have varying levels of resolution. At step 918, a determination is made as to whether or not the image already exists in system 100. If image 158, 163 already exists is system 100, the method proceeds to steps 920 where the existing original image 380 and its associated processed versions 390 are replaced with the new image and its new processed versions. At step 922, the existing image domain data record 350 for the image is updated with the new metadata information from the new image and the method ends. Alternatively, if image 158, 163 does not already exist in system 100, the method proceeds to step 924 where the original image 380 and the new processed images 390 associated with upload image 158, 163 are moved to image library 175 associated with data layer 300. At step 926, an image domain data record 350 is created for the new image.

At step 928, a determination is made as to whether or not the new image is associated with a photography assignment by examining the metadata associated with the image. If the new image is associated with a photography assignment, at step 930 the image is submitted to the corresponding photography assignment for review by image editor 140 and method 900 ends. Alternatively, if a determination is made that the new image is not associated with a photography assignment, the method proceeds to step 932 where a determination is made as to whether or not the new image is a stock image submission by examining the metadata associated with the image. If a determination is made that the new image is a stock image submission, the method proceeds to step 834 where the image is marked for review by stock image processing and key-wording interface 480 and method 900 ends. Alternatively, if a determination is made that the image is not a stock image submission, method 900 ends.

Although example methods are illustrated, the present invention contemplates two or more steps taking place substantially simultaneously or in a different order. In addition, the present invention contemplates using methods with additional steps, fewer steps, or different steps, so long as the steps remain appropriate for processing a new, uploaded image 158, 163 using IP manager 570.

Example of Resolving “Unassociated” Release Documents

FIG. 11A illustrates an example method 1000 for resolving “unassociated” release document images (or unassociated release images). The method begins at step 1002 where a list is displayed of all unassociated release images in a specific photography assignment. In certain embodiments, the list is sorted with reference to the associated photographer who uploaded each release image. At step 1004, an internal user of system 100, such as image editor 160, selects a release image to be resolved. At step 1006, the release image is displayed, which may include a picture of the model or property associated with the contract embodied in the release image. At step 1008, thumbnail images are displayed of each image 158 that the photographer has uploaded related to the specific photography assignment of interest. At step 1010, image editor 160 checks, or otherwise selects, all images 158 related to the release document scan. At step 1012, the relationship of the release image to each selected upload image 158 checked in step 1010 is saved in the image domain data 350. At step 1014, a determination is made as to whether or not more unresolved release images must be resolved. If no further release images need to be resolved, method 1000 ends. Alternatively, if more release document scans must be resolved, method 1000 returns to step 1004 to resume the process described in steps 1004-1014.

Although example methods are illustrated, the present invention contemplates two or more steps taking place substantially simultaneously or in a different order. In addition, the present invention contemplates using methods with additional steps, fewer steps, or different steps, so long as the steps remain appropriate for resolving unresolved release document scans.

Example of Image Downloading

FIG. 11B illustrates an example method 1050 for downloading an image 158, 163 using image manager 580. The method begins at step 1052 where image manager 580 receives a request to access an original, high-resolution image 380. At step 1054, a determination is made s to whether or not the request was issued from an internal user, such as salesperson 130, assignment editor 140, image editor 160, stock editor 170, or any other appropriate internal user of system 100. If the download request was issued by an internal user of system 100, the method proceeds to step 1062 where the download is approved, image data is transferred from system 100 to the internal user, and method 1050 ends. Alternatively, if the download request was not issued by an internal user of system 100, the method proceeds to step 1056 where a determination is made as to whether of not the request was issued by the photographer who owns the image 380. If the download request was issued by the photographer who owns the image, the method proceeds to step 1062 where the download is approved, image data is transferred from system 100 to the photographer, and method 1050 ends.

Alternatively, if the download request was not issued by the photographer who owns the image, the method proceeds to step 1058, where a determination is made as to whether or not the request was issued by a customer 102 who has been approved to access the image by license manager 600. If customer 102 issued the download request and is an approved licensee of the image as determined by license manager 600, the method proceeds to step 1062 where the download is approved, image data is transferred from the system 100 to the customer 102, and method 1050 ends. Alternatively, if the download request did not come from a customer 102 who is an approved licensee of the image, the method proceeds to step 1060 where the download request is rejected and method 1050 ends.

Although example methods are illustrated, the present invention contemplates two or more steps taking place substantially simultaneously or in a different order. In addition, the present invention contemplates using methods with additional steps, fewer steps, or different steps, so long as the steps remain appropriate for downloading an image in response to an approved download request.

Although the present invention has been described with several embodiments, a multitude of changes, substitutions, variations, alterations, and modifications may be suggested to one skilled in the art, as it is intended that the invention encompass all such changes, substitutions, variations, alterations, and modifications as fall within the spirit and scope of the appended claims.

What is claimed is:

1. A method for providing images to a customer, comprising:
receiving a request for at least one image from a customer;
using software on a computer server to:
select a plurality of photographers from a photographer network in response to the request;
receive an uploaded image from each of at least two photographers;
display the uploaded images to the customer for selection of at least one image in fulfillment of the request; and
providing a selected uploaded image to the customer after the customer agrees to execute a license to use the uploaded image.

2. The method of claim 1, further comprising:
generating customer license data associated with the customer and the selected uploaded image; and
storing the customer license data in a database.

3. The method of claim 1, wherein the request identifies at least one of an image selection and a customer use criteria.

4. The method of claim 3, wherein the method further comprises:
searching a plurality of stock images stored in an image database in response to the request; and
determining that either of the image selection criteria or the customer use criteria is not met by the plurality of stock images; and
wherein the software is used to select the plurality of photographers from the photographer network after it is determined that the image selection criteria or the customer use criteria is not met.

5. The method of claim 4, wherein determining that the customer use criteria is not met by the plurality of stock images comprises:
displaying existing license data associated with a particular stock image to a user; and
receiving an input from the user indicating that the existing license data prohibits use of the image in a manner identified by the customer use criteria.

6. The method of claim 4, wherein determining that the customer use criteria is not met by the plurality of stock images comprises comparing existing license data associated with a selected stock image to the customer usage criteria.

7. The method of claim 1, further comprising:
creating customer usage criteria in response to the request;
searching a plurality of stock images stored in an image database in response to the request; and
determining that the customer use criteria is not met by the plurality of stock images; and
wherein the software is used to select the plurality of photographers from the photographer network after it is determined that the customer use criteria is not met.

8. The method of claim 1, wherein the request identifies at least one of an image selection and a customer use criteria, and the method further comprises using the software on the computer server to:
search a plurality of stock images stored in an image database in response to the request;
determine that either of the image selection criteria or the customer use criteria is not met by the plurality of stock images; and
select the plurality of photographers from the photographer network after it is determined that the image selection criteria or the customer use criteria is not met.

9. The method of claim 1, further comprising generating customer license data from the sales order.

10. The method of claim 1, further comprising storing license data associated with the uploaded image in a database, the license data comprising at least usage data.

11. The method of claim 1, further comprising negotiating, with the customer, one or more license terms to be incorporated into the license, the terms negotiated when the request for the image is received from the customer.

12. The method of claim 1, wherein selecting the one or more photographers is based at least in part on one or more photographer ratings associated with each photographer.

13. The method of claim 1, wherein selecting the plurality of photographers from the photographer network in response to the request comprises:
generating an assignment invitation in response to receiving the request;
selecting a plurality of photographers from the photographer network to each receive the assignment invitation; and
communicating the assignment invitation to the selected photographers.

14. The method of claim 13, wherein selecting the plurality of photographers from the photographer network in response to the request further comprises:
receiving a response from each of at least two invited photographers indicating a desire to fulfill the request; and
selecting at least two shooters from the invited photographers to fulfill the request.

15. A system for providing images to a customer, comprising:
a customer manager operable to receive a request for at least one image from a customer;
a photographer selection subsystem operable to select a plurality of photographers from a photographer network in response to the request;
an image manager in communication with the photographer selection subsystem, the image manager operable to:
receive an uploaded image from each of at least two photographers;
cause a graphical interface to display the uploaded images to the customer for selection of at least one image in fulfillment of the request; and
provide a selected uploaded image to the customer after the customer agrees to execute a license to use the uploaded image.

16. The system of claim 15, further comprising a license manager operable to:
generate customer license data associated with the customer and the selected uploaded image; and
store the customer license data in a database.

17. The system of claim 15, wherein the request identifies at least one of an image selection and a customer use criteria.

18. The system of claim 17, wherein image manager is further operable to:
search a plurality of stock images stored in an image database in response to the request; and
determine that either of the image selection criteria or the customer use criteria is not met by the plurality of stock images; and
wherein the photographer selection subsystem is operable to select the plurality of photographers from the photographer network after it is determined that the image selection criteria or the customer use criteria is not met.

19. The system of claim 18, wherein when determining that the customer use criteria is not met by the plurality of stock images the image manager is further operable to:
cause existing license data associated with a particular stock image to be displayed to a user on a graphical user interface screen; and
receive an input from the user indicating that the existing license data prohibits use of the image in a manner identified by the customer use criteria.

20. The system of claim 18, wherein when determining that the customer use criteria is not met by the plurality of stock images the image manager is further operable to compare existing license data associated with a selected stock image to the customer usage criteria.

21. The system of claim 15, wherein
the customer manager is operable to create customer usage criteria in response to the request;
the image manager is operable to search a plurality of stock images stored in an image database in response to the request and determine that the customer use criteria is not met by the plurality of stock images; and
the photographer selection subsystem is operable to select the plurality of photographers from the photographer network after it is determined that the customer use criteria is not met.

22. The system of claim 15, wherein:
the request identifies at least one of an image selection and a customer use criteria, and the method image manager is further operable to search a plurality of stock images stored in an image database in response to the request and determine that either of the image selection criteria or the customer use criteria is not met by the plurality of stock images; and
the photographer selection subsystem is operable to select the plurality of photographers from the photographer network after it is determined that the image selection criteria or the customer use criteria is not met.

23. The system of claim 15, wherein a license manager is in communication with the image manager, the license manager operable to generate customer license data from the request.

24. The system of claim 15, wherein a license manager is in communication with the image manager, the license manager operable to store license data associated with the uploaded image in a database, the license data comprising at least usage data.

25. The system of claim 15, wherein the license comprises one or more license terms negotiated when the request for the image is received from the customer.

26. The system of claim 15, wherein the photographer selection subsystem is operable to select the one or more photographers based at least in part on one or more photographer ratings associated with each photographer.

27. The system of claim 15, wherein when selecting the plurality of photographers from the photographer network the photographer selection subsystem:
generates an assignment invitation in response to receiving the request;
selects a plurality of photographers from the photographer network to each receive the assignment invitation; and
communicates the assignment invitation to the selected photographers.

28. The system of claim 27, wherein when selecting the plurality of photographers from the photographer network the photographer selection subsystem:
receives a response from each of at least two invited photographers indicating a desire to fulfill the request; and
selects at least two shooters from the invited photographers to fulfill the request.

29. Logic for providing images to a customer, the logic encoded in media and operable when executed to:
select a plurality of photographers from a photographer network in response to receiving a request, from a customer, for at least one image;
receive an uploaded image from each of at least two photographers;
display the uploaded images to the customer for selection of at least one image in fulfillment of the request; and
provide a selected uploaded image to the customer after the customer agrees to execute a license to use the uploaded image.

30. The logic of claim 29, further operable when executed to:
generate customer license data associated with the customer and the selected uploaded image; and
store the customer license data in a database.

31. The logic of claim 29, wherein the request identifies at least one of an image selection and a customer use criteria.

32. The logic of claim 31, further operable when executed to:
search a plurality of stock images stored in an image database in response to the request; and
determine that either of the image selection criteria or the customer use criteria is not met by the plurality of stock images; and
select the plurality of photographers from the photographer network after it is determined that the image selection criteria or the customer use criteria is not met.

33. The logic of claim 32, further operable, when determining that the customer use criteria is not met by the plurality of stock images, to:
display existing license data associated with a particular stock image to a user; and
receive an input from the user indicating that the existing license data prohibits use of the image in a manner identified by the customer use criteria.

34. The logic of claim 32, further operable, when determining that the customer use criteria is not met by the plurality of stock images, to:
compare existing license data associated with a selected stock image to the customer usage criteria.

35. The logic of claim 29, further operable when executed to:
create customer usage criteria in response to the request;
search a plurality of stock images stored in an image database in response to the request;
determine that the customer use criteria is not met by the plurality of stock images; and
select the plurality of photographers from the photographer network after it is determined that the customer use criteria is not met.

36. The logic of claim 29, wherein the request identifies at least one of an image selection and a customer use criteria, and the logic is further operable when executed to:
search a plurality of stock images stored in an image database in response to the request;
determine that either of the image selection criteria or the customer use criteria is not met by the plurality of stock images; and
select the plurality of photographers from the photographer network after it is determined that the image selection criteria or the customer use criteria is not met.

37. The logic of claim 29, further operable when executed to generate customer license data from the sales order.

38. The logic of claim 29, further operable when executed to store license data associated with the uploaded image in a database, the license data comprising at least usage data.

39. The logic of claim 29, wherein the license comprises one or more license terms negotiated when the request for the image is received from the customer.

40. The logic of claim 29, further operable when executed to select the one or more photographers is based at least in part on one or more photographer ratings associated with each photographer.

41. The logic of claim 29, wherein when selecting the plurality of photographers from the photographer network the logic is further operable to:
generate an assignment invitation in response to receiving the request;
select a plurality of photographers from the photographer network to each receive the assignment invitation; and
communicate the assignment invitation to the selected photographers.

42. The logic of claim 41, wherein when selecting the plurality of photographers from the photographer network the logic is further operable when executed to:
receive a response from each of at least two invited photographers indicating a desire to fulfill the request; and
select at least two shooters from the invited photographers to fulfill the request.
